(19) United States
(12) Patent Application Publication
(10) Pub. No.: US 2011/0050687 A1
(43) Pub. Date: Mar. 3, 2011

(54) Presentation of Objects in Stereoscopic 3D Displays

(76) Inventors: Denis Vladimirovich Alyshev, Stratchlyde (GB); James McGinley, Strathclyde (GB); Anwar Majid, Strathclyde (GB)

(21) Appl. No.: 12/936,354

(22) PCT Filed: Apr. 2, 2009
(86) PCT No.: PCT/GB2009/050325

§ 371 Date: Nov. 9, 2010

(30) Foreign Application Priority Data
Apr. 4, 2008 (GB) 0806183.0

(51) Int. Cl. G06T 15/00

(52) U.S. Cl. 345/419

(57) ABSTRACT

A data processing system includes a rendering system adapted to process data objects to render display frames for presentation via a visual display screen. The display frames include 2D display items corresponding to the data objects, each display item having a 2D screen location within the display frame defined by reference to an X/Y display plane. The rendering system renders stereoscopic 3D views of display frames by rendering left- and right-eye views of the display frames. The left- and right-eye views of the display frames are rendered by processing the data objects corresponding to the 2D display items such that respective left- and right-eye copies of the 2D display items are included in the left- and right-eye views. A set of 3D effects rules is provided that specify relationships between stereoscopic 3D effects and parameters associated with the data objects corresponding to the 2D display items. The stereoscopic 3D effects include lateral offsets in the X-direction of the X/Y display plane to be applied when rendering left- and right-eye copies of display items at respective screen locations, such that selected 2D display items may be perceived by a viewer as being displaced along a Z-axis perpendicular to said X/Y plane. Corresponding computer-implemented methods and computer program products are also included.

### FIELD OF THE INVENTION

The invention relates to the visual display of information using stereoscopic, three-dimensional (3D) visual display technology. More particularly, the invention is concerned with methods and systems whereby data representing 2D information that is to be displayed by means of a stereoscopic visual display unit is processed such that selected elements of the information displayed will be perceived by a viewer as being displaced in a direction perpendicular (z-direction) to the plane of the screen (x/y plane) of the visual display unit.

### BACKGROUND TO THE INVENTION

A variety of 3D visual display technologies are known in the art, all of which (apart from volumetric displays that form a visual representation of an object in three physical dimensions, as opposed to the planar image of traditional screens) are based on the well known principles of stereoscopy whereby slightly different 2D views of a 3D subject are presented to each of the viewer's eyes, thereby creating the illusion of depth. As is well known, the separation of the views presented to each eye by such display technologies may also be achieved in a variety of ways, including the use of differently coloured or polarised filters, head-mounted displays with a separate display screen for each eye, and so-called autostereoscopic displays that do not require glasses or headsets; e.g. using lenticular lenses or parallax barriers. Lenticular displays actually display multiple versions of the relevant images, different pairs of which are visible to a viewer depending on the viewing angle, but the 3D effect obtained still relies on stereoscopy. It is also known to obtain a limited 3D effect on a conventional 2D display by visibly flipping the display between left and right images of a stereoscopic image pair. This provides an impression of the 3D shape of a pictorial subject but is of limited practical usefulness. Existing stereoscopic 3D visual display technologies also include systems using projected images (the screen of any kind of visual display and any surface onto which a display is projected may be regarded as a “screen” for present purposes).

Generally speaking, such display technologies are intended for use in displaying 3D renderings of pictorial subject matter, whether for entertainment purposes (3D television and cinema, video gaming) or for scientific, technical or industrial applications. That is, known 3D visual display solutions are typically concerned with the presentation of subject matter that is inherently three-dimensional.

Classical stereoscopy involves capturing separate images of a real 3D subject from laterally displaced positions, to obtain a stereoscopic pair of images that can be presented to the viewer's left and right eyes by any suitable means. 3D computer modelling also allows “genuine” stereoscopic image pairs to be synthesised from 3D model data. Computer technology further allows 3D computer models to be constructed based on one or more 2D images of a 3D subject, using sophisticated algorithms.

As is also well known, a “pseudo-stereoscopic” 3D effect can be obtained on the basis of an approximation of a stereoscopic pair of images derived from copies of a single 2D image, with the image presented to one eye being laterally displaced (x-direction) relative to the other. The term “pseudo-stereoscopic” and associated terms as used herein refer to this type of effect.

The term “synthetic stereoscopy” is also used in reference to techniques whereby a stereoscopic pair is synthesised from a single 2D image. Such techniques generally involve methods whereby a “depth map” is derived somehow for a pictorial 2D image, representing the z-direction displacement (“z-displacement”) of each pixel of the image—see for example WO97/47141. However, such methods are quite different from what is contemplated by the present invention which, as explained below, employs simple copies of 2D display items to generate screen displays incorporating stereoscopic effects.

EP0712110 and EP0717373 are each concerned with providing stereoscopic display effects, particularly in the context of video game systems, by presenting first and second copies of display items to the left and right eyes of the viewer, with the copies offset horizontally (laterally) from each other such that different items are perceived as having different z-displacements. As described further below, this particular type of stereoscopic effect is referred to herein as a “PS3D” effect for brevity and convenience. EP0712110 and EP0717373 discuss the application of such PS3D effects particularly in the context of video games, for the purpose of providing a sense of depth between 2D background images and 2D foreground objects, such as sprite images. They do not teach or suggest that such effects might usefully be applied to enhance the appearance, user-experience and functionality of general purpose computer displays or graphical user interfaces (GUIs), or how a general purpose display rendering system might be adapted in order to apply such effects to a variety of different types of objects on the basis of a variety of different criteria associated with such objects.

Conventional GUIs employ a 2D display, and are sometimes described as “2½ D” (2.5 D) by virtue of the fact that objects in the GUI environment can overlap and have a “stacking order” or “z-order”. There has long been interest in the idea of 3D GUIs, however this idea generally relates to the use of a fully 3D environment, using a 3D GUI space populated by 3D GUI objects. 3D GUIs of this type have not seen practical use outside of particular specialised applications, usually of a highly technical nature. Fully immersive 3D GUI environments are an extension of this. Known 3D GUI concepts may or may not involve 3D display technology; i.e. they include 3D environments represented on 2D displays.

The present invention does not seek to provide a 3D computing environment as such in the sense that is usually implied by references to 3D GUIs, 3D content and the like. It is concerned rather with the use of 3D display technology to enhance the appearance, user-experience and functionality of essentially conventional 2D and/or 2.5 D screen displays and user interfaces.

### SUMMARY OF THE INVENTION

The present invention, in its various aspects, concerns the use of certain types of pseudo-stereoscopic 3D effects when displaying information via 3D display technology; for example, to introduce a 3D visual aspect to the display of material that would normally be considered to be inherently two-dimensional, such as documents, web pages and conventional GUI environments. For brevity, the abbreviation “PS3D” will be used for “pseudo-stereoscopic 3D” in relation to the 3D effects provided by the invention.

Broadly speaking, given a set of graphical objects that are to be displayed, subsets of those objects may be defined to which a given PS3D effect is to be applied. Any object to which such an effect is to be applied will be displayed by rendering, via any suitable 3D display technology, a pair of laterally displaced copies (left-eye and right-eye copies) of the object in respective views of the overall display content that are presented to the left and right eyes by means of the 3D display technology.

For the purposes of the present description, content to be displayed according to the invention may comprise a plurality of “display items” that would “normally” be displayed in 2D, without any 3D effects. That is, any display item to which a PS3D effect is applied would, if displayed in the absence of such an effect, have an “unmodified 2D screen location”. In general terms, the application of a PS3D effect to a display item causes left-eye and right-eye copies of the display item to be displayed at respective screen locations that are laterally offset from one another relative to the unmodified 2D screen location.

The display is generated by a rendering system of a computer or other data processing system, which include mobile telephones and other portable devices. As used herein, “display item” refers to items as they appear on a display screen and the term encompasses any subset of screen display content to which a PS3D effect can be selectively applied independently of the remainder of the display content. In the context of a data processing system, a display item is rendered on the screen by processing one or more “data objects” corresponding to the display item and defining its 2D visual appearance.

As will also be discussed further in the detailed description below, a “correct” 3D representation of an original 2D display item, for a given z-axis displacement, would also require the copies of the item to be scaled according to direction and extent of the z-axis displacement—items to be perceived as being behind the display plane should be reduced in scale and items to be perceived as being in front of the display plane should be increased in scale, the size of the reduction or increase being dependent on the required z-distance. Again, for the purposes of the present invention, this is not always necessary. A useful PS3D effect may be obtained without such scaling. Further, scaling or other transformations of the original 2D display item may be applied to the copies for the purpose of creating a particular visual effect, other than a “correct” stereoscopic rendering. For example, it may also be noted that strictly correct 3D rendering would also require some rotation of the original display item. This may not generally be significant for the purposes of the present invention and might not normally be done, but is not excluded as a possibility.

The content of a particular display may include “genuine” (intrinsically) 3D/stereoscopic content such as 3D images or video, which conventionally would be displayed in the context of a 2D environment. In such cases PS3D effects may be applied to display elements other than the intrinsically 3D content.

While it may generally be expected that the types of display items to which PS3D effects are most likely to be applied will themselves be planar in character (i.e. the PS3D effect will result in the viewer perceiving a flat/2D object displaced in the z-direction), an item may comprise multiple elements to which differing PS3D effects are applied, so that the viewer perceives the item itself as having 3D properties.

Most stereoscopic 3D display technologies will only require one left- and one right-eye copy of a display item. Some, however, particularly autostereoscopic technologies such as lenticular displays, require the generation of multiple copies. It will be understood that the invention embraces the use of multiple copies as required for such display technologies by simple extension of the principles underlying basic pseudostereoscopic pairs.

More or less complex rules may be applied to the PS3D rendering of display content comprising multiple display items of multiple types, where particular types of items may have varying properties. In a simple case, all display items of one particular type may have the same PS3D parameters applied to them. At the next level of complexity, the PS3D parameters applied to one type of item may vary as a function of some property of that type of item. At a still higher level of complexity, where several types of display item each have their own property-dependent PS3D parameters, the rules may specify that some or all PS3D parameters vary depending on the relative numbers and/or properties and/or position and/or proximity of display items of particular types or properties, or combinations of types and/or properties.

PS3D effects for specified display items may be applied and/or varied on the basis of user interaction with displayed items. For example, user selection of an item such as a text string or an icon or a window may cause the selected object to be “brought forward” or “highlighted” in 3D (“PS3D-highlighting”). The relative z-displacements of multiple objects might indicate the order in which or the length of time since the objects were selected by the user, etc. Provision may be made for a user to switch PS3D effects on or off, or to adjust the effects, entirely or on a selective basis, or to define or customise PS3D rules.

PS3D effects for specified display items may also be applied and/or varied on the basis of other system events. For example, incoming email may cause an icon representing an email client or email message to be PS3D-highlighted.

PS3D effects may be applied to display items in accordance with specified temporal or other parameters. For example, particular display content such as advertising content may be rendered in PS3D so as to vary in visual prominence (z-distance) according to a time schedule; the relative z-axis prominence of objects may be determined on the basis of factors such as sponsorship, popularity among a network user community, history of selection/use by an individual user, etc. PS3D effects may further be associated with particular screen locations; for example, a particular effect may be applied to any content displayed in a particular area of a web page. Also, PS3D effects may be applied to display items at or in proximity to the screen position of a pointer or cursor—this may apply to any pointing devices such as mice, trackballs and touchpads, and also to fingers and styli in the case of touch sensitive screens.

Further, PS3D effects may themselves be dynamic/animated and/or transient in nature; e.g. selection of a display item may cause it to move progressively forward in the z-direction and then move back to the display plane. Dynamic and/or transient effects of this kind may also be combined with other movements or transformations of the object, such as changes of scale and/or rotations about any of the x, y and z axes, or combinations of such movements or transformations.

PS3D effects may also be applied to objects in combination with other visual effects, such as colour changes and/or geometric distortion of the object (e.g. fisheye, barrel or pincushion distortion).

The perceived PS3D effect may be augmented by other visual 3D cues, such as the rendering of a shadow of a display item on an underlying desktop or other underlying display items.

The PS3D effects may be specified and applied at any appropriate point(s) in the process of generating the display output, depending at least in part on the nature of the display rendering system in use, the nature and purpose of the PS3D effects/rules, and the nature of the source data from which the displayed items are derived.

A visual display rendering system or “engine” of a type that operates on the basis of generating a display output from a plurality of discrete data objects can be adapted to apply PS3D effects to those data objects as an integrated part of the rendering process. This may be done on the basis of pre-defined rules relating to data object types and properties, and/or in response to user input or system events, etc. as described above. In such cases neither the source data from which the data objects are derived nor any upstream system functions need define the PS3D effects.

In a display rendering system that maintains knowledge of the display content in terms of data objects and associated properties/parameters up until final rendering of a particular display screen, PS3D rules may be defined within and applied entirely by the rendering system, independently of upstream data processing functions and without any need for the source data to have been created with PS3D effects in mind.

Regardless of the nature of the display rendering system, PS3D rules may be defined upstream of the rendering system, instead of or in addition to such rules being defined within the rendering system. For example, an operating system may define PS3D rules that are to be applied to the visual display of any display items, including GUI objects native to the operating system, objects native to application programs, and objects native to data files or data formats etc. Further, additionally or alternatively, PS3D effects may be defined within application programs and/or within data files and/or data formats.

It will be understood that, as used herein, PS3D “rules” (or “3D effects rules”) generally refers to the criteria according to which PS3D effects are applied, including criteria whereby pre-existing rules, such as style rules associated with source data for example, are interpreted such that PS3D effects are applied instead of or in combination with whatever effect might be defined by the pre-existing rules.

It will be understood further that one important consequence of certain preferred embodiments of the invention is that 3D display effects may be applied to source data which was not created with any 3D display effects in mind, on the basis of style rules, attributes or the like associated with the source data. Further, the source data need not be modified in any way for the purposes of applying such effects when processing the source data to generate a visual display.

Further aspects of the invention concern the application or maintenance of 3D visual effects while, for example, zooming or panning a view of a displayed object, or during the process of generating or updating a particular view of an object. These aspects of the invention apply, at least in certain applications, to 3D content in which 3D effects are obtained by means other than the presently described PS3D effects.

It can be seen from the foregoing that stereoscopic 3D effects are applied selectively to 2D display items. Data objects corresponding to the display items are processed to generate a display of the display items. In processing the data objects, 3D effects rules are applied on the basis of parameters associated with the data objects. The 3D effects rules determine the display items to which 3D effects are to be applied and the nature of such effects (particularly, the z-axis displacement that is to be applied). The 2D display items are rendered on the display screen such that a first rendering of the display items may be presented for viewing by a right eye of a viewer of the display and a second rendering of the display items may be presented for viewing by a left eye of the viewer. In rendering a display item to which a 3D stereoscopic effect is applied, a lateral offset is applied in the X-direction of the X/Y display plane, associated with the selected stereoscopic effect, relative to the 2D screen location of the item. The offset is applied between a first rendered position of the 2D display item in the first rendering, and a second rendered position of the 2D display item in the second rendering, such that the 2D display item may be perceived by the viewer as being displaced along the z-axis perpendicular to said X/Y plane.

The present invention in its various aspects embraces data processing methods, systems, computer programs and data file formats that apply, or enable the application of, PS3D effects to visual display content in accordance with the general principles and more particular functionalities outlined above and described further below.

A data processing system according to an embodiment of the invention includes a rendering system adapted to process data objects to render display frames for presentation via a visual display screen. The display frames include 2D display items corresponding to the data objects and each display item has a 2D screen location within the display frame defined by reference to an X/Y display plane. The rendering system is adapted for rendering stereoscopic 3D views of display frames to be displayed on a display screen by rendering left- and right-eye views of the display frames, the left- and right-eye views of the display frames being rendered by processing the data objects corresponding to the 2D display items such that respective left- and right-eye copies of the 2D display items are included in the left- and right-eye views of the display frames. A set of 3D effects rules is provided that specify relationships between stereoscopic 3D effects and data object parameters associated with the data objects corresponding to the 2D display items. The stereoscopic 3D effects include lateral offsets in the X-direction of the X/Y display plane to be applied when rendering left- and right-eye copies of display items at respective screen locations, such that selected 2D display items may be perceived by a viewer as being displaced along a Z-axis perpendicular to said X/Y plane.

The data processing system may include a GUI and application programs that enable a user to access, manipulate or otherwise interact with information on the data processing system. The rendering system is adapted to receive as data inputs data representing items that are to be displayed from applications running on the data processing system and/or from the GUI, and to apply the 3D effects rules to objects derived from the data inputs.

The rendering system may be adapted to receive as data inputs data comprising document files or other data structures representing visual information and to apply the 3D effects rules to data objects derived from the document files or other data structures.

The rendering system may be further adapted to process a display list that defines parameters of a set of data objects corresponding to 2D display items and to process the display list to generate left- and right-eye views of a display frame by applying the 3D effects rules to a set of objects derived from the display list on the basis of the parameters defined by the display list.

A computer-implemented method, according to an embodiment of the invention, applies stereoscopic 3D effects to the display of 2D display items on a visual display screen in a data processing system that includes a rendering system adapted to process data objects to render display frames for presentation via the visual display screen. The display frames include 2D display items corresponding to the data objects and each display item has a 2D screen location within the display frame defined by reference to an X/Y display plane. A set of 3D effects rules is provided in the data processing system that specify relationships between stereoscopic 3D effects and data object parameters associated with the data objects corresponding to the 2D display items. The stereoscopic 3D effects include lateral offsets to be applied when rendering left- and right-eye copies of display items. For each of a set of data objects corresponding to display items that are to be rendered in a display frame, it is determined by reference to the data object parameters and the 3D effects rules whether any 3D effects are to be applied to that data object. The data objects are processed to generate left- and right-eye copies of the display items. The processing includes applying any lateral offsets specified by any applicable 3D effects rule to the 2D screen locations of the left- and right-eye copies of the display items. The left- and right-eye copies of the display items are rendered into left- and right-eye views of the display such that respective left- and right-eye copies of the display items are included in the left- and right-eye views of the display frames at respective screen locations that are laterally offset in the X-direction of said X/Y display plane in accordance with the 3D effects rules, such that 2D display items may be perceived by a viewer as being displaced along a Z-axis perpendicular to said X/Y plane.

The visual appearance of the display items may be determined by processing via the rendering system the data object parameters associated with the data objects corresponding to the 2D display items.

The data processing system may include a GUI and application programs that enable a user to access, manipulate or otherwise interact with information on the data processing system. The rendering system may receive as data inputs data representing items that are to be displayed from applications running on the data processing system and/or from the GUI. The method may include applying the 3D effects rules to objects derived from the data inputs.

The rendering system may be adapted to receive as data inputs data comprising document files or other data structures representing visual information. The method may further include deriving data objects from the document files or other data structures and applying the 3D effects rules to the data objects so derived.

The rendering system may receive as input a display list that defines parameters of a set of data objects corresponding to 2D display items.

The method may include processing the display list to generate the left- and right-eye views of a display frame by applying the 3D effects rules to a set of objects derived from the display list on the basis of the parameters defined by the display list.

Embodiments of the invention will now be described, by way of example only, with reference to the accompanying drawings.

### BRIEF DESCRIPTION OF THE DRAWINGS

FIG. 1 is a set of diagrams 1A, 1B and 1C illustrating the optical principles of the PS3D effect exploited by the preferred embodiments of the present invention;

FIG. 2 is a representation of a simple document as an example for explaining an embodiment of the present invention;

FIG. 3 is a diagram illustrating a coordinate system employed in an exemplary embodiment of the present invention;

FIG. 4 is a flow diagram illustrating a 2D rendering process;

FIG. 5 is a table of 3D effects rules according to an exemplary embodiment of the invention;

FIG. 6 is a flow diagram illustrating a 3D rendering process according to an exemplary embodiment of the invention;

FIG. 7 is a diagram illustrating the application of lateral offsets in left- and right-eye copies of a display item according to an exemplary embodiment of the invention;

FIG. 8 is a table of 3D effects rules with metadata according to an exemplary embodiment of the invention;

FIG. 9 is a table of 3D effects rules with user interface events according to an exemplary embodiment of the invention;

FIG. 10 is a diagram illustrating the application of lateral offsets in left- and right-eye copies of a window containing nested components according to an exemplary embodiment of the invention;

FIG. 11 is a table of 3D effects rules for a PS3D GUI according to an exemplary embodiment of the invention;

FIG. 12 is a diagram illustrating the application of lateral offsets and scale transforms to display items according to an exemplary embodiment of the invention;

FIG. 13 is a block diagram illustrating a rendering system in accordance with an exemplary embodiment of the invention.

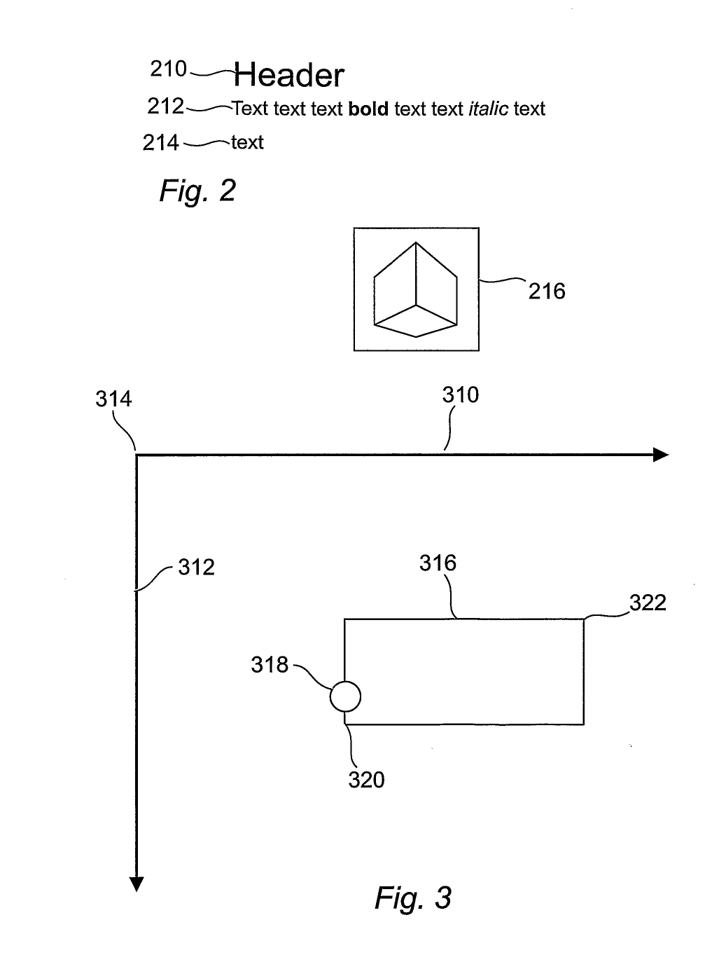

Reference is also made to Appendices 1 and 2 annexed to the present description which are, respectively, a display list for the document of FIG. 2 and a listing of an object based representation of the document of FIG. 2.

### DETAILED DESCRIPTION OF PREFERRED EMBODIMENTS OF THE INVENTION

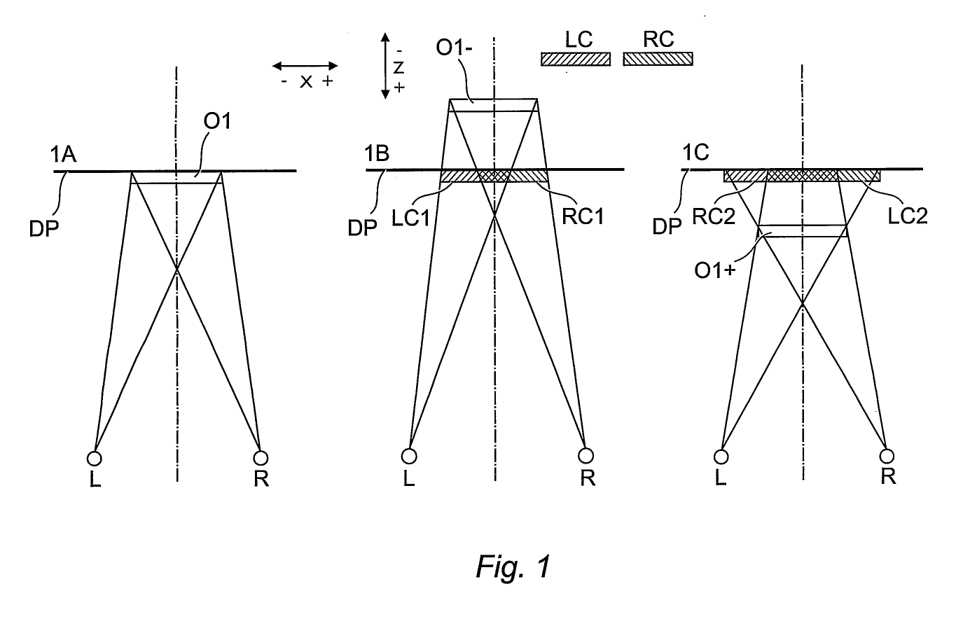

Referring now to the drawings, FIG. 1 illustrates the optical principles of the PS3D effect that forms the basis for the preferred embodiments of the invention. In FIG. 1, directions x and z are indicated, L and R are the left and right eyes of a viewer, DP is the plane of the screen of a visual display unit (display plane), O1 is a display item displayed on the screen, and LC and RC are left- and right-eye copies (“PS3D copies”) of the item O1 created for the purpose of creating a PS3D effect. The item O1 is a 2D (x/y) graphical object and is shown having a thickness in the z-direction for clarity of illustration only.

Note: The use of “positive” and “negative” in relation to the x- and y-directions herein follows the convention for co-ordinate systems in computer displays, where the origin is at the top left of the display screen.

Thus, the positive x-direction is from left to right and the positive y-direction is from top to bottom. For the z-direction, as used herein “positive” means in the direction out of the X/Y plane towards the viewer.

Diagram 1A illustrates the situation in the conventional 2D display of the item O1. Both eyes see the same display of the item O1, which is perceived to lie on the display plane DP.

Diagram 1B shows the situation where the item O1− is to be perceived as being displaced in the (negative) z-direction behind the display plane DP. A first copy LC1 of the item O1 is displayed at the display plane DP and presented to the left eye, displaced to the left in the negative x-direction relative to the position of item O1 in diagram 1A. A second copy RC1 of the item O1 is displayed at the display plane DP and presented to the right eye, displaced to the right in the positive x-direction relative to the position of item O1 in diagram 1A. In this example the PS3D copies LC1 and RC1 overlap on the display plane as shown by the hatching.

Diagram 1C shows the situation where the item O1+ is to be perceived as being displaced in the (positive) z-direction in front of the display plane DP. A first copy LC2 of the item O1 is displayed at the display plane DP and presented to the left eye, displaced to the right in the positive x-direction relative to the position of item O1 in diagram 1A. A second copy RC2 of the item O1 is displayed at the display plane DP and presented to the right eye, displaced to the left in the negative x-direction relative to the position of item O1 in diagram 1A. Again, the PS3D copies LC2 and RC2 overlap on the display plane as shown by the hatching.

The x-direction displacements applied to the left and right eye copies of display items in order to achieve a perceived z-displacement are referred to herein as “offsets”. From the foregoing, it can be seen that the offsets, relative to the original 2D display location, required for positive and negative z-displacements are as follow (Table 1):

TABLE 1

| z-displacement | Left eye offset | Right eye offset |
|---|---|---|
| (Z) | (LEO) | (REO) |
| Negative (−z) | Negative (−x) | Positive (+x) |
| Positive (+z) | Positive (+x) | Negative (−x) |

As can be seen from the diagrams, the degree and direction of displacement of the perceived display item in the z-direction depends on the degree and direction of displacement of the left- and right-eye copies at the display plane. It can also be seen that for a negative z-direction displacement, the copies LC1 and RC1 should be reduced in scale relative to the original item, and for a positive z-direction displacement, the PS3D copies LC2 and RC2 should be increased in scale relative to the original item.

The diagrams of FIG. 1 illustrate the displacements and scaling of copies of display items required for a “correct” stereoscopic representation of the item O1 displaced along the z-axis by a particular distance. For the purposes of the present invention, it will not always be the case that a strictly correct representation is required (in fact, it may generally be the case that it is not). For a particular item within a display of multiple items to exhibit some z-axis displacement, it is only necessary that the left- and right-eye copies of the item be shifted relative to each other in the x-direction. Also, scaling of the copies is not necessary in order to obtain a visible PS3D effect. At a minimum, a useful PS3D effect can be obtained if the view for one eye displays the item at its original scale and at its unmodified 2D screen location (i.e. this first view is identical to a normal 2D display of the same content), and the view for the other eye displays a copy of the item, again, at its original scale, but offset in the x-direction by some amount relative to its position in the first view.

It will be understood, nevertheless, that additional shifting and/or scaling and/or other transformations of one or both copies of the original display item may be applied in order to obtain a particular visual effect, and that such effects may be dynamic/animated and/or transient in nature.

The basic parameters for the PS3D effect will typically be (a) whether or not a PS3D effect is to be applied to a display item or class of display items; (b) the degree of lateral (x-axis) offset of the left- and right-eye copies (defined, for example, in inches or other suitable units, or as a proportion of the x-axis dimension of the display item), which determines the perceived depth by which the item is displaced in the z-direction (z-axis displacement); (c) the relative direction of lateral (x-axis) offset of the left- and right-eye copies, which determines whether the item is perceived to be in front of or behind the display plane. Alternatively, (b) and/or (c) could be specified by reference to the z-axis displacement and the required x-axis offset(s) computed therefrom.

In broad terms, the preferred embodiments of the present methods require 3D effects rules to be specified within a computer or other data processing system that renders a screen display via a stereoscopic 3D visual display. The 3D effects rules are applied to data objects corresponding to display items that are to be rendered as part of the screen display. The data objects are generally derived from source data representing documents or other kinds of information that are inherently two-dimensional and intended for “normal” presentation on a 2D visual display by means of a 2D rendering system. The present invention can be embodied in a rendering system in which otherwise conventional 2D rendering processes are modified to generate stereoscopic display outputs suitable for driving a 3D visual display.

Two dimensional rendering systems and associated methods and functionality of this type, suitable for adaptation for the purposes of the invention, are disclosed in WO01/79984, WO01/80044, WO01/80183, WO01/79980, WO01/80178, WO01/80069 and WO03/034272. In general terms, these systems may receive as input source data in any of a variety of formats. The systems convert the source data into an internal object and parameter based format. The data objects thus derived from the source data are then processed for final rendering on a visual display. Exemplary embodiments of the invention will be described with reference to such a 2D rendering system. The skilled person will appreciate that the following description of a particular 2D rendering system is merely illustrative, and that other object-based approaches for 2D rendering as are common in the art may be utilised and adapted to equal effect.

2D Rendering System

For the purposes of the present description, content to be displayed may comprise a plurality of “display items” that would “normally” be displayed in 2D, without any 3D effects. As used herein, “display item” refers to items as they appear on a display screen. In the context of a data processing system, a display item is rendered on the screen by processing one or more “data objects” corresponding to the display item and defining its 2D visual appearance. The ‘rendering system’ as used herein refers to the system which processes the data objects to produce the display items to be presented on the visual display. The following description of a 2D rendering system is provided to explain the process of 2D display rendering, by way of background to the subsequent description of how such a system can be adapted to implement PS3D effects. As such, certain embodiments and features of 2D rendering systems are “preferred” in the sense that they facilitate the implementation of PS3D effects.

In a preferred embodiment, the set of data objects to be rendered exists in the form of a ‘display list’. In this context, a display list is a data structure comprising a linked list of data objects with one or more associated parameters which are processed by the rendering system to produce display frames containing the corresponding display items. The data object also contains the data content to be rendered, such as the string of text to appear on the display, or the set of coordinates to draw a vector. As used herein, the term “display frame” refers to a single, complete screenful of information as intended to be presented on the visual display. Each update of the display will require the current display frame to be updated or a new display frame to be generated.

A single display frame may contain one or more display ‘windows’ or containers each containing distinct sets of display items, as is known in the art.

The data object parameters will typically include a data object type. Data object types may include, without limitation, one or more of image object, text object, video object, hyperlink object, advertisement, GUI object, vector graphic object, window object, box object, table object, and animation object. The rendering system may use the object type information to direct the processing to a particular rendering module which handles the particular data object type. For example, data objects which are text-type objects may be directed to a text-rendering module which contains functions appropriate to the rendering of text; image-type objects may be directed to an image-rendering module which has functions for rendering bitmap images or compressed image formats. The rendering system may thus be composed of a plurality of such type-specific modules or subsystems which operate to process the full display list containing a mixture of object types. Such a system has benefits in terms of modularity, extensibility and consistency of display.

Each data object will typically have one or more associated parameters which further characterise the data object. These parameters are interpreted by the rendering system to instruct the processing, resulting in the application of properties to the corresponding display items such as size and visual appearance. Relevant data object parameters may include a style associated with a data object:

e.g. for text objects: font, font size, bold, italic, underlined, alignment, justification;

for image objects: border style, transparency;

for vector line objects: line thickness, dotted, dashed;

In the preferred embodiment, each data object in the display list contains a pair of position coordinates which identify the location of the data object in a two dimensional coordinate space. These define the position, in physical units, where the rendering system should place the corresponding display item relative to a common origin defined within the display list. A single display list may for example comprise the data objects contained in a single page of a digital document, in which case the top left corner of the page may be defined as the common origin for the position coordinates of each data object in the display list. Since the display item has finite size, the position coordinates specified in the data object typically define the point from which the display item originates, for example the bottom left-most corner of the display item.

The coordinate space employed in the display list is generally predetermined and fixed by the system designers. In a typical system the entire set of display items will have different dimensions from the physical display, so that mechanisms such as scrolling may be necessary to view selected display items. The size of display items may also be varied in a typical system by applying scale or zoom factors to the display. The techniques for transforming between the coordinate space of the display list, and the screen coordinates of the physical display, are well known in the art. In the context of the present invention, the term ‘rendering system’ is used to include the functions which implement these techniques. The embodiment as described herein assumes that the position coordinates contained in the display list are a property of the information to be displayed, independent of the display screen dimensions. After rendering, each display item is positioned at a screen location which is related to the data object's position coordinates after taking account of any transform or scaling factors.

For performance reasons, the rendering system may take steps to minimise the amount of processing it has to do. One of the most significant steps is to quickly identify data objects in a display list that are completely outside the areas of the document and/or screen being updated. These data objects can be immediately eliminated from any further processing.

At any time, the rendering system may be rendering only a partial view of a document within a display frame and hence on the display screen. There is no need, then, to render an object (or parts of an object) that will not appear in the display screen. To facilitate this, each data object may contain a bounding box, which describes the extremities of the corresponding display item in the same coordinate space used for the position coordinates. The exclusion process works by comparing the bounding box of each individual data object with the display screen redraw area. Data objects that are entirely off-screen are excluded from the rendering of a current display frame.

In the context of a display frame containing more than one container or window object, the exclusion may be applied relative to the visible area of the associated window or container, which may be smaller than the display screen.

The rendering system processes the display list as described above to generate the visible display items contained within a current display frame, taking account of any scale or other transformations. Displaying the information on a computer display ultimately involves the step of converting the data into a display frame comprising a set of colour values corresponding to each pixel on the display screen. This process is known as scan conversion or rasterising, and is well known in the art. The output of the rendering system, following scan conversion, is thus a set of pixel colour values which represent the display items on the display screen. The output data may be rendered directly to the display memory of the computing device, or it may be stored in a buffer memory to be subsequently loaded into the display memory.

The display list of data objects to be processed by the rendering system may be constructed in a number of ways that are known in the art. In a preferred embodiment, the display list may be generated by a ‘layout’ module operating on an object-based representation of the data to be processed. In this context an object-based representation is one which describes the information content, style and structure as a set of identifiable objects each of a predetermined type, and with an associated set of properties which further characterise the object. Examples of such an object-based representation include the W3C Document Object Model (DOM) for representing documents expressed in HTML or XML, and the object model disclosed in WO01/79984, WO01/80044, WO01/80183, WO01/79980, WO01/80178, WO01/80069 and WO03/034272 for representing documents in a variety of source formats.

A common characteristic of object-based representations is the existence of a styling syntax which attaches style properties to an object. The style properties can define presentation rules that determine how document objects may be formatted and rendered. A well known example of such a styling syntax is the W3C Cascading Style Sheets (CSS) syntax.

A layout module operating on an object-based representation may interpret the structure, content and style information to produce a display list of the type described above. A benefit of such a system is that the data objects and their parameters in the display list may be associated respectively with objects and their style properties within the object representation. The association may be made by a scheme of object pointers or data handles or other mechanisms. The layout module also creates the position coordinates for each data object in the display list.

Alternatively or additionally, the display list may be generated by a layout module operating on data derived from input source data in the form of markup such as HTML data. In this arrangement, the types of data object and parameters contained in the display list may be derived from markup tags in the source data. For example, the <img> tag in HTML may correspond to a data object of type ‘image’; the heading <h1>, <h2>, <h3> tags may each correspond to data objects of type ‘text’ but with different parameters to distinguish the different implied heading styles.

By way of illustration, a worked example is shown in FIG. 2 and Appendix 1 (annexed to the present description) for a simple document containing text of varying styles and an image. FIG. 2 is a view of the displayed document as it would appear after rendering by a rendering system of the type described, for example on a computer screen. Appendix 1 is a print-out of the display list for the same document. The display list may be described by reference to the line numbers in Appendix 1.

An excerpt covering lines 52-58 of the display list on in Appendix 1 is copied below:

```
Text object ptr: 1ef26ec, Edr ptr: 1ef147c, parent: 1ef0d68 ::
  Position (0.04,−0.93) Bounding box (0.00, −0.06)-(0.52, 0.15)
  font: size=11.13, style=Normal, weight=700, variant=Normal
  mode: Kerning
  spacing: letter=0.00, word=0.00
  colour: 00,00,00/ff
  string: len=6, ‘Header’
```

This excerpt describes a single data object and its associated parameters in the display list; i.e. the word “Header” 210 in FIG. 2. The first line identifies the item as a text object, and specifies a hexadecimal pointer to the address in memory of this object (‘ptr: 1 ef26ec’). There is also a pointer to an associated object in the object-based representation (called Edr in this example embodiment), and a pointer to the parent data object in the display list (‘parent: 1ef0d68’). In this example it may be seen that the parent is a box object at line 38 of the display list.

The next line shows the position coordinates (‘Position (0.04,−0.93)’) of the data object. These are coordinates, in inches, from an origin at the top left corner of the document to be displayed. The bounding box shows the extremities of the displayed item as a pair (xmin, ymin)−(xmax, ymax) of points at the corners of a rectangle relative to the position coordinates. See FIG. 3, which shows X- and Y-axes 310 and 312, having an origin 314, a display item bounding box 316 and (xmin, ymin) and (xmax, ymax) coordinates 320, 322 relative to the data object's position coordinates 318, which may be regarded as an ‘anchor’ position for the object.

The next four lines describe various parameters associated with this data object, such as font size, weight and colour. The last line of the excerpt shows the actual data content of the object, in this case the text string ‘Header’.

It can be seen from the example in Appendix 1 that a further six text objects, beginning at lines 66, 73, 80, 87, 94, and 101, combine to produce the next two lines of text 212 and 214 that appear in FIG. 2. The first data object at line 66 contains a data string with multiple words. However the next word to be displayed (‘bold’) has different parameters which indicate it is to be rendered as bold text (weight=700 at line 75). For that reason it may not be combined with the preceding string which has weight 400 and so a new data object is included in the display list. Similarly the data objects at lines 80, 87, 94 and 101 illustrate how a change of rendering parameters or a new line of text lead to distinct data objects in the display list.

The path objects at lines 108 and 111 contain the information to render the rectangular vector path which sits around the image 216 in FIG. 2. The ImageURL object at line 114 contains a pointer to the address of the image to be rendered within the rectangular path.

Appendix 2 contains a listing of the object-based representation from which the display list, as shown in Appendix 1, is generated. In the example embodiment, the display list is generated by processing the object-based representation through a layout module, as described earlier. Aspects of the relationship between the object-based representation and the corresponding display list may be illustrated with reference to Appendices 1 and 2.

In Appendix 2, the list of objects can be seen between lines 63 to 102. In this example the object-based representation uses the concept of ‘groups’ as a container for other objects, such as text objects. The earlier part of the listing from lines 4 to 59 describes object styling properties which are referenced by the various objects.

As an example, lines 66-67 of Appendix 2 (reproduced below) refer to a group object of type textGroup which in turn contains a text object whose data content is the text string ‘Header’.
Group,@ 1ef1448 type textGroup (19) styles [unknown:21d]
   Text,@ 1ef147c ‘Header’

The properties of the text object are inherited from the textGroup which specifies that it is to take the properties referenced at ‘styles [unknown:21d]’ in the representation. These style properties may be seen at lines 33-36 of Appendix 2, as follows:

```
[unknown:21d]: FontWeight = Bold,
      FontFamily = (string “Arial”),
      EpageWordFEFontFamily = (string “MS Mincho”),
      FontSize = (len = 0.222214)
```

After processing through the layout component, this text object is seen to correspond to the data object at lines 52-58 of the display list in Appendix 1 and as reproduced above. Note also that the hexadecimal address 1ef147c appearing at line 67 of the object-based representation is retained as a pointer on the data object as may be seen at line 52 of Appendix 1 (‘Edr ptr: 1ef147c’). By this mechanism the rendering system may utilise not only the information contained directly in the data objects and parameters of the display list, but indirectly may also utilise further information of relevance from the document object by following the address pointer.

To illustrate this point further, the Path object at line 108 of the display list in Appendix 1 has a pointer to the document object at hexadecimal address 1ef21c0. However the Path object itself does not describe how the path is to be drawn. Instead, that information is supplied by reference back through the address pointer to the object at lines 92-96 of Appendix 2, reproduced below, which define the corners of the rectangular path to be drawn:

Path,@ 1ef21c0 (5 elements)move to (0.000000,0.000000).
line:start=(0.000000,0.000000),end=(1.135422,0.000000).
line:start=(1.135422,0.000000),end=(1.135422,1.081940).
line:start=(1.135422,1.081940),end=(0.000000,1.081940).
close:start=(0.000000,1.081940),end=(0.000000,0.000000).

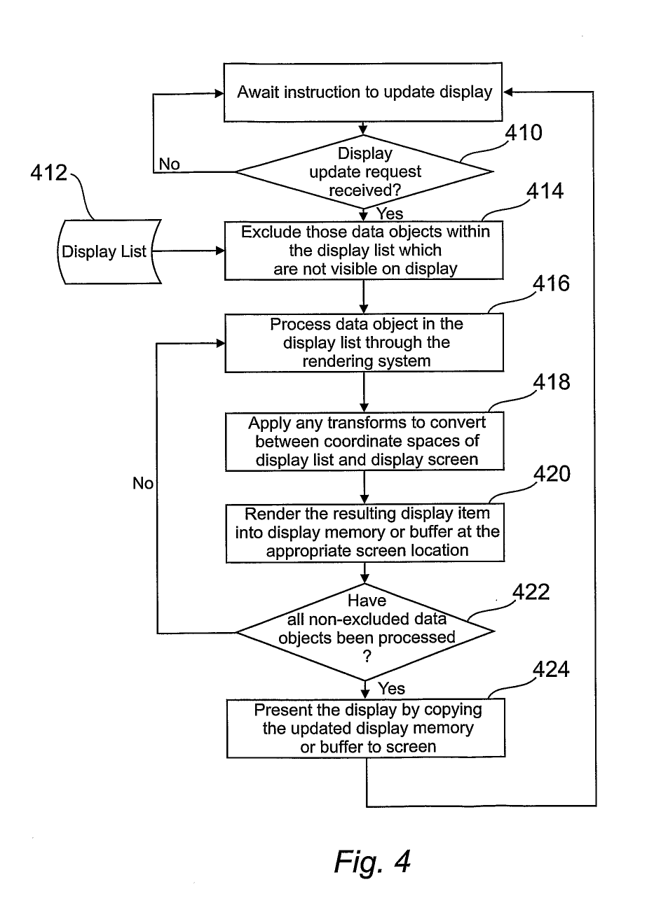

The overall sequence of two dimensional rendering is shown in FIG. 4. The rendering process is activated at 410 by a request to update the display. Such requests can originate, without limitation, from user action, from an application program, from a user interface event, or from a system event such as an alert. On receipt of the request the positional information contained in the position coordinates, and bounding boxes if they are included, within the display list 412 is used at 414 to exclude any data objects which are not visible on the new display to be created. The remaining data objects are processed one by one through the rendering system at 416, which interprets the object parameters and, at 418, applies any two-dimensional transforms to the size, location or orientation relative to the data object's position coordinates, to produce a corresponding display item at the desired screen location within the display frame. The display items are rasterised into the pixel locations in display or buffer memory at 420. If a buffer is used, the final step, once it has been determined at 422 that all non-excluded objects have been processed, is to copy the final updated display frame of display items to the physical screen at 424.

Stereoscopic 3D Effects

The two-dimensional rendering system of the type described above is characterised by the ability to interpret a predetermined set of data object types and parameters. The purpose of these object types and parameters is to inform and instruct the rendering system regarding the processing to be applied so as to produce a set of display items with the desired visual appearance. The processing is applied consistently for objects having the same object type and parameters, and is independent of the actual content of the data object.

The preferred embodiments of the present invention utilise this type of characteristic of known 2D rendering systems to allow the selective application of stereoscopic 3D effects to individual data objects by exposing the data object types and parameters to a 3D effects rules module. This rules module may contain one or more rules which specify a relationship between particular data object parameters and a selected stereoscopic 3D effect. The specific application of the 3D effects rules to particular objects is based on parameters associated with the data objects. Such parameters include parameters that are intrinsic to particular data objects or types of data objects (e.g. object type, font size), and parameters that are extrinsic to the data objects but associated with particular data objects on the basis, for example, of user interaction (e.g. user selection of one or more display items) or events within the data processing system.

The stereoscopic effect for a particular rule may be expressed in terms of a lateral displacement (offset) in the horizontal X direction to be applied to left and right eye renderings of the data objects having the particular parameters specified in the rule. In a preferred embodiment, the offset is defined by a single value, +x or −x. The sign + or − indicates a positive or negative displacement in the X-axis of the display plane. In this example, a positive offset value means that the left-eye copy of the object is to be displaced in the positive X direction and a negative offset value means that the left-eye copy of the object is to be displaced in the negative X direction. The value x indicates the size of the offset in any suitable units, such as inches. The position coordinates of the selected data object may then be adjusted by applying the lateral offset (e.g. +x) prior to rendering the data objects into a left-eye copy of the display items, and applying the complement of the lateral offset (−x) prior to rendering into a right-eye copy of the display items. The left- and right-eye copies may then be displayed via any suitable 3D display technology to create the effect of displacing the corresponding display item in a Z-axis perpendicular to the X/Y display plane.

Table 1 above shows how positive and negative offsets in the left- and right-eye copies translate into positive and negative z-displacements. It can be seen that in the present example a positive offset value indicates a positive left-eye offset and a negative right-eye offset, and thus corresponds to a positive z-displacement. A negative offset value indicates a negative left-eye offset and a positive right-eye offset, and thus corresponds to a negative z-displacement.

It will be appreciated that the embodiment described above in which an offset (+x or −x) and its complement (−x or +x) are applied would result in both the left- and right-eye copies of the original display item being displaced in opposite lateral directions from the unmodified 2D screen location of the item. For the purposes of the present invention, however, this is not always necessary. One of the copies may be displayed at the unmodified 2D screen location of the display item and the other copy displayed with a lateral displacement dependent on the desired PS3D effect (i.e. one of the left- and right-eye display views would be exactly the same as it would be in a normal 2D display of the same content, while the display item is laterally displaced in the other of the left- and right-eye display views).

It should also be understood that in conventional, pictorial stereoscopy and pseudostereoscopy, a 3D visual effect will only be obtained if differences exist between the images presented to each eye. That is, if the complete content of a display as presented to one eye is identical to the display content as displayed to the other eye, no 3D effect will be perceived regardless of any relative lateral displacement of the overall display views as presented to each eye. In the context of the present invention, however, any particular display item to which a PS3D effect is applied will only be one element of a display whose content comprises a number of elements. Accordingly, even if the copies of the display item presented to the left and right eyes are completely identical, apart from their respective laterally displaced display positions, the overall display views presented to the left and right eyes will be different by virtue of the different, laterally displaced positions of the respective copies in the context of the respective display views. Therefore, a stereoscopic visual effect may be obtained such that the display item will be perceived as having a z-axis displacement relative to the display screen, based only on lateral displacement of identical copies of the display item in the context of a display frame in which the display item is only one of a number of display items.

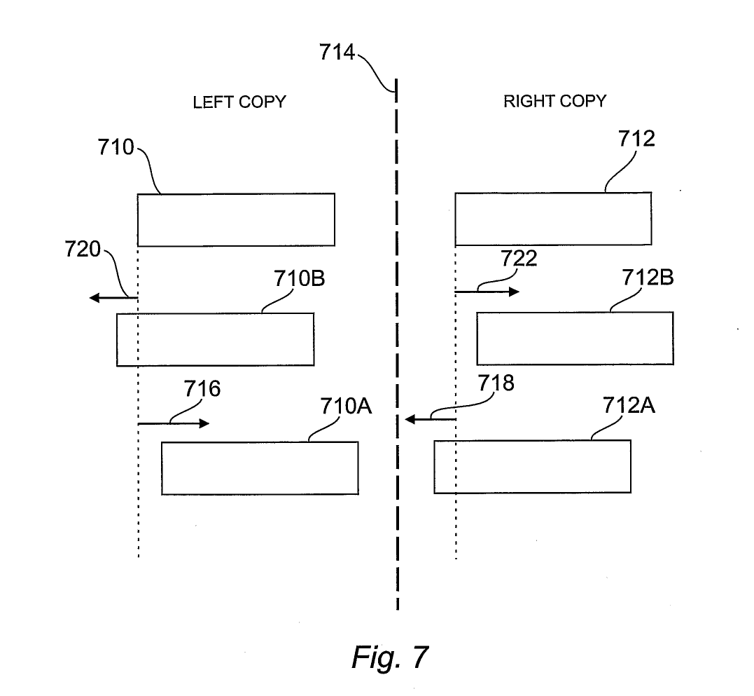

The effect of applying a lateral offset to the left and right copies is shown in FIG. 7 (see also Table 1 above). Left and right copies of a display item are shown at their unmodified positions 710 and 712 relative to a central axis 714. A positive lateral offset value has the effect of shifting the display item 710A in the left-eye copy in the positive X direction 716 i.e. towards the right, and shifting the display item 712A in the right-eye copy in the negative X direction 718 i.e. towards the left. Displaying the left and right eye copies through a suitable 3D display technology has the effect that a positive lateral offset is interpreted by the human eye as positioning the display item in front of the X-Y display plane and thus corresponds to a positive z-displacement (towards the viewer). A negative lateral offset has the opposite effect of shifting the left-eye copy 7108 in the negative X direction 720 (to the left) and the right-eye copy 712B in the positive X direction 722 (to the right), so positioning the display item behind the display plane and thus corresponds to a negative z-displacement (away from the viewer). The skilled person will appreciate that the positive and negative directions for the lateral offset are simply a matter of convention and may be reversed so long as a consistent meaning is applied throughout the system.

The method of the invention may be illustrated by demonstrating the selective application of PS3D effects to the example of the two-dimensional document and display list of FIG. 2 and Appendix 1. In that example, the rendering system has the ability to interpret data object types that include at least text, path and image objects and to apply the parameters attached to such data objects to generate the desired visual display.

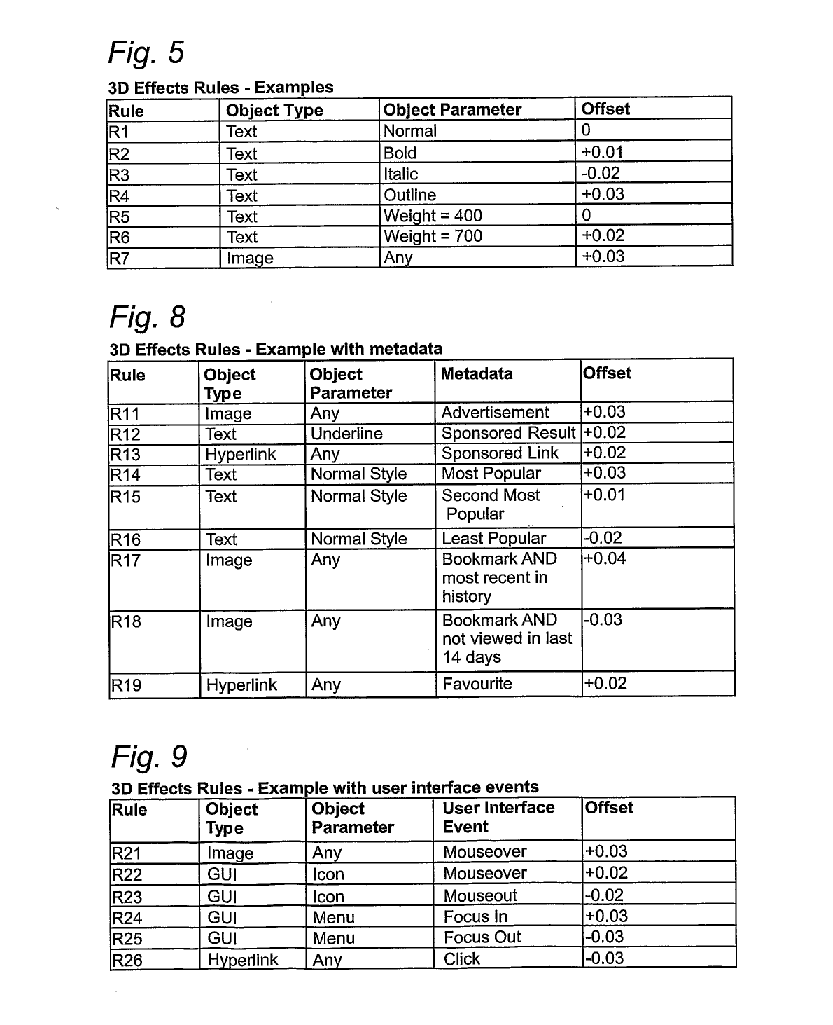

In one embodiment of the present invention, a 3D effects rules module may be created containing a set of rules as shown in FIG. 5. In this example a table of seven rules R1-R7 is defined, each rule specifying a relationship between particular data object parameters and a selected stereoscopic effect. As described above, the stereoscopic effect is expressed as a lateral offset to be applied to the position coordinates of the data object so as to create a relative displacement between copies of the corresponding display item in a left-eye and right-eye view. The offset in this example is defined in inches. It will be appreciated that other choice of units, and other ways of specifying the relationship between data object parameters and 3D effects, may be employed within the context of the invention.

As a general point, it will be understood that object types or object parameters for which zero offset is to be applied (i.e. no z-displacement is required) may simply be omitted from a set of 3D effects rules so that the default treatment of a an object is to apply no offset.

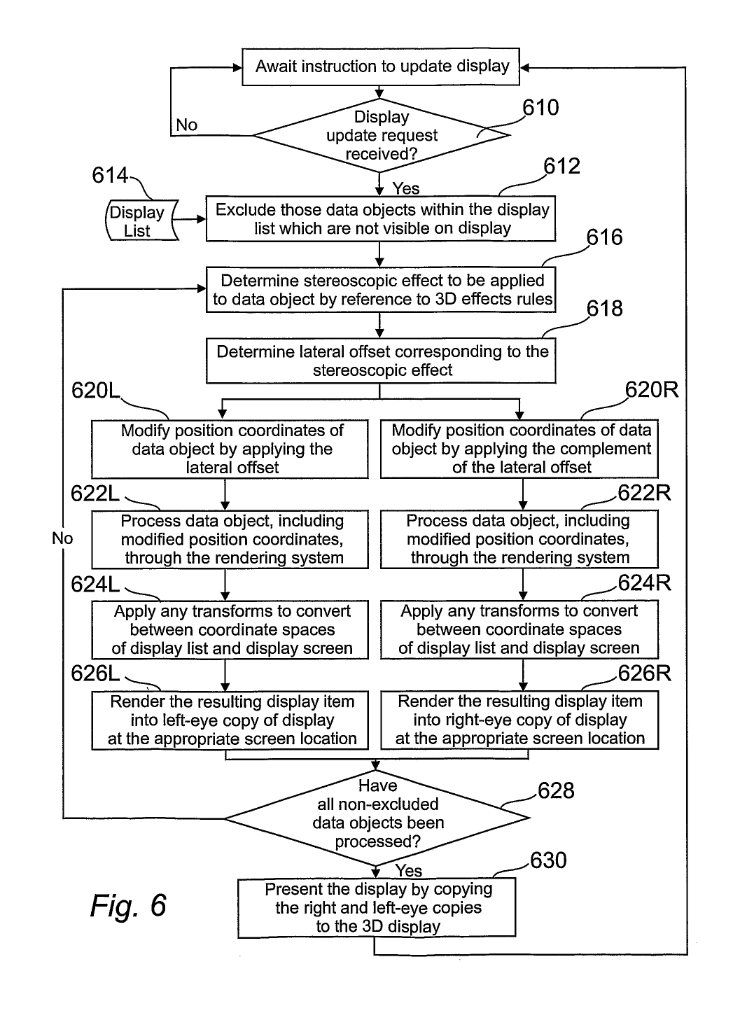

The sequence of constructing the display to include the desired 3D effects is shown in FIG. 6. On receiving a request to update the display at 610, the exclusion process 612 is applied to the display list 614 as before to limit the processing only to those data objects which will be at least partially visible on the display. Each remaining data object may then be processed by the 3D effects rules module, by comparing the data object parameters against each rule at 616 to determine, at 618, a related 3D effect to be applied. The 3D effects may then be expressed in terms of the lateral offsets to be applied.

The position coordinates of the data object may then be adjusted by applying the lateral offset to the X-coordinate at 620L, and directing the data object with modified coordinates to the rendering system to generate a display item within the left-eye view of the display frame: 622L-626L, corresponding to 416-420 in FIG. 4. The right-eye view is created in an equivalent manner, but after first applying the complement of the lateral offset to the data object's position coordinates: 620R-626R.

When all of the non-excluded data objects have been processed in this way, as determined at 628, the left and right-eye views of the display frame may be presented on the 3D display, 630, in a manner consistent with the particular 3D display technology being used.

The skilled person will appreciate that it is not essential to wait until all data objects have been processed before presenting an updated display. Techniques such as progressive and partial rendering, which provide display updates as the display processing is still continuing, may be applied without departing from the present invention.

Whilst the left and right copy rendering processes 620L-626L and 620R-626R are shown as separate, parallel processes in FIG. 6, it will be appreciated that this representation of the processing is schematic. The rendering processes for left and right copies of a particular object may be substantially identical and need be done only once for both copies of the object.

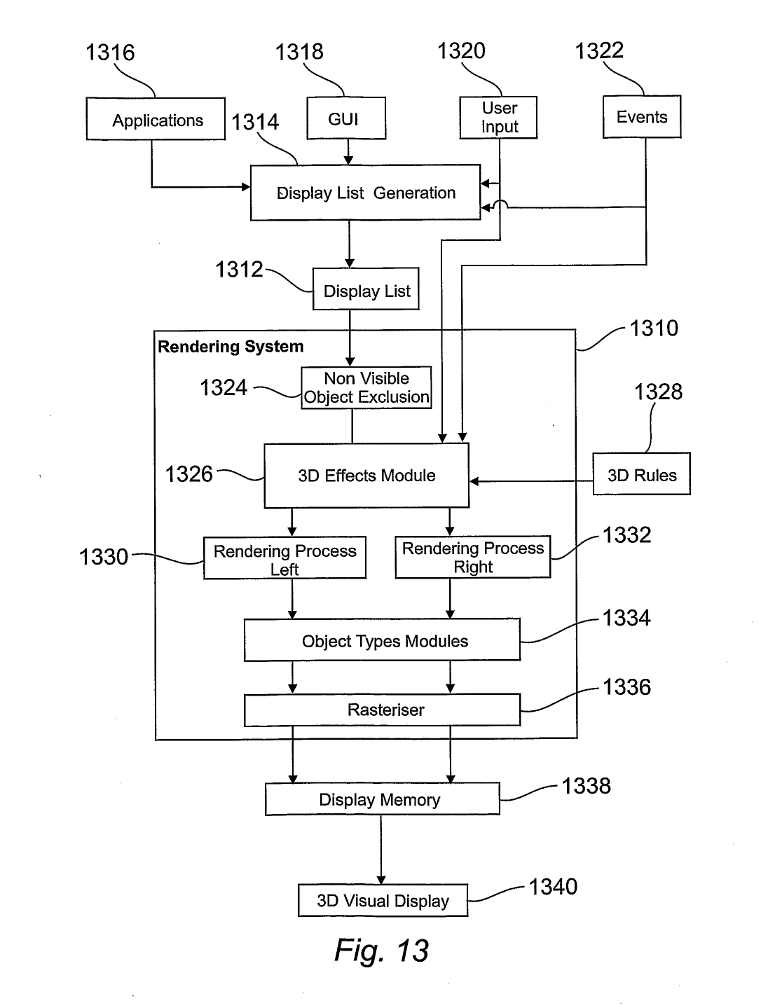

FIG. 13 shows an exemplary embodiment of a rendering system 1310 for implementing the processes described above. The rendering system 1310 typically exists within a host data processing system. Such systems include personal computer systems, mobile communications devices, personal digital assistants, media players, and any other device or system that provides computing and user interface functions for accessing, manipulating or otherwise interacting with information and application programs, typically including a processor, memory, 3D visual display and user input means such as keyboards, keypads, touch screens and pointing devices.

The rendering system 1310 receives as input a display list 1312 representing items that are to be displayed.

The display list 1312 is generated by a display list generation component 1314 (such as a layout module as described above), which receives as input data from applications 1316 running on the host system and/or the GUI 1318 of the host system, and may also be capable of directly processing document files or other data structures representing visual information. The input data representing the display items may be input in the form of data objects or may be in a format that is capable of being converted into suitable data objects by the display list generation component 1314, as is well known in the art.

The inputs received by the display list generation component 1314 are processed to generate the display list 1312, which defines the properties of all of the objects to be considered for inclusion in the visual display.

In preferred embodiments of the rendering system 1310, the display list 1312 is processed in a non-visible object exclusion process 1324, to exclude from further processing those objects that will not be visible in the rendered display frame. Non-excluded objects are then passed to a 3D effects module 1326 for testing against the 3D rules defined within a 3D rules module 1328. The 3D effects module may also receive user input 1320 and events 1322 as control inputs which are not directly representative of display items, but which affect the content of the visual display frame. Based on such testing, the 3D effects module 1326 provides input to left- and right-eye view rendering processes 1330 and 1332 which, together with object type modules 1334 and rasteriser 1336, then render the complete left and right copies of the display frame into display memory 1338 or directly to 3D visual display 1340.

It will be understood that the operation of the object type modules 1334 and rasteriser 1336 may be substantially identical to a conventional 2D rendering system. The data object types and parameters are interpreted by the 2D rendering system to influence the visual appearance of the display items, Exposing these same data object types and parameters for use within the 3D rules thus makes for an efficient system with relatively little modification to the 2D rendering system. Similarly, the conventional 2D rendering system processes the position coordinates of the data objects to determine the screen locations, and this same processing can be applied without modification to create left- and right-eye views of each display frame by applying appropriate offsets to the position coordinates in each view.

It will further be understood that this embodiment is merely an example, showing how 3D effects rules may be incorporated into a rendering system that may be otherwise similar to any of a number of conventional 2D rendering systems. The particular manner in which the 3D effects rules are incorporated into and interact with the rest of the system in order to generate the left and right copies will depend on the details of the system. For example, the 3D rules module may be provided either as an integral part of the rendering system or, as illustrated, externally of the rendering system, providing additional data input thereto. The manner and the extent to which 3D effects rules and associated 3D processing may be integrated into any pre-existing 2D rendering system will also depend on the operational details of the existing system and the extent to which it is desired to re-engineer the existing system to accommodate and exploit the possible uses of the 3D effects disclosed herein.

In general terms, the rendering system will test each object against the 3D effects rules, in terms of the object's type and/or other relevant parameters, and then apply any relevant rule(s) in the subsequent processing of the object. For this purpose, the rendering system may include a 3D effects/rules module, or may cooperate with a 3D effects/rules module that is otherwise included within the data processing system. The system needs to be capable of associating relevant offsets with relevant objects and generating left and right views of the display content in which the respective positive and negative offsets are applied to the respective display locations of the corresponding objects in the respective views.

Returning to the example, the effects rules specified in FIG. 5 may be applied to the data objects in FIG. 2/Appendix 1 to produce a display with 3D effects as follows. It is assumed for this purpose that all of the display items are visible on the display and none are excluded.

TABLE 2

| | Lines re | Rules | | Coordinates | Coordinates |
|---|---|---|---|---|---|
| Object | FIG. 2 | from FIG. 5 | Offset | Left Copy | Right Copy |
| Text | 52-58 | R1, R6 | 0 + 0.02 | (0.06, −0.93) | (0.02, −0.93) |
| Text | 66-72 | R1, R5 | 0 | (0.04, −1.46) | (0.04, −1.46) |
| Text | 73-79 | R1, R6 | 0 + 0.02 | (0.84, −1.46) | (0.80, −1.46) |
| Text | 80-86 | R1, R5 | 0 | (1.09, −1.46) | (1.09, −1.46) |
| Text | 87-93 | R3, R5 | −0.02 + 0 | (1.60, −1.46) | (1.64, −1.46) |
| Text | 94-100 | R1, R5 | 0 | (1.92, −1.46) | (1.92, −1.46) |
| Text | 101-107 | R1, R5 | 0 | (0.04, −1.64) | (0.04, −1.64) |
| Path | 108-110 | null | 0 | (0.04, −2.84) | (0.04, −2.84) |
| Path | 111-113 | null | 0 | (0.04, −2.84) | (0.04, −2.84) |
| Image | 114-118 | R7 | +0.03 | (0.07, −3.93) | (0.01, −3.93) |

When rendered via the rendering system and presented on a suitable 3D display, the document in FIG. 1 will have stereoscopic effects as follows:
The text strings ‘Header’ and ‘bold’ will appear to sit in front of the XY plane of the display (text objects at lines 52 and 73 respectively)
The text string ‘italic’ will appear to be behind the plane (text object at lines 87)
The image will appear to be in front of the plane, by a greater amount than the ‘Header’ and ‘bold’ text stings.

The other display items in the document will have no displacement in the Z direction.

As will be apparent from the example, the fact that a data object can have multiple parameters means there may be a many-to-one relationship between the effects rules and a data object. For example rules R1 and R6 both apply to the first text object in the table, because it has normal style (rule R1) and weight 700 (rule R6). In such cases, the net offset to be applied to the data object is the arithmetic sum of the offsets from each rule that applies to the data object. For example, a text object with Outlines style and weight 700 would, if subject to the effects rules of FIG. 5, have a lateral offset of +0.03+0.02=+0.05 inches (rules R4 and R6).

From the foregoing, it can be seen that a data object may have multiple parameters that are subject to different 3D effects rules, and the rendering system is adapted to apply a combination of the lateral offsets specified by those different rules when applying the 3D effects rules to that data object.

Further, one or more 3D effects rules may specify the modification—by alteration, removal, addition or substitution—of one or more data object parameters associated with a data object having the particular parameters specified in the 3D effects rule, and the rendering system may be adapted to process the set of data objects to produce respective left- and right-eye copies of the corresponding display item according to the modified parameters for the data object.

For the purposes of generating displays for autostereoscopic display units, such as those employing lenticular screens, multiple copies of the corresponding 2D display item may be generated and rendered with appropriate relative offsets, for inclusion in multiple right- and left-eye renderings of the display items as may be required for use with such autostereoscopic visual displays. The specific details of the multiple renderings will depend on the requirements of particular types of display unit, but can easily be derived on the basis of the present teaching.

The preferred embodiment has the benefit that it makes use of an existing display list or equivalent as would be generated by a typical two-dimensional rendering system. In this way it is possible to apply 3D effects to information which is inherently 2D in nature, in the sense that the information was authored for 2D presentation and designed for processing in a 2D data processing system.

The invention has further benefit in terms of its flexibility. The 3D effects which appear in the display may be varied simply by modifying the 3D rules. For example, the example rules in FIG. 5 result in bold text appearing in front of the display plane and italic text behind. This appearance could easily be modified simply by specifying different offsets, for example to make bold text appear in front, behind or within the display plane, and by variable amounts. In this way a single 2D document may be presented with a limitless variety of 3D effects, without the need to modify the original document. The offsets specified in the rules may also be variables whose values are determined or adjusted in response to user input (e.g. via a 3D effects control, as discussed further below) or some other input to the rendering system and/or 3D rules module.

In a preferred embodiment, the 3D effects rules module will consume the effects rules as a data input to the module. This allows the rules to be easily modified simply by changing the module's data input, with no changes required to the module's algorithms, functions or processing.

In a data processing system that employs the invention, the 3D effects rules may optionally be stored in whole or in part as data with the two dimensional document or object data, to be supplied as input to the 3D effects module when the document or object is processed. In this way, for example, a single two-dimensional document may be saved in multiple versions, each having a different set of 3D effects rules which are applied to give a different stereoscopic appearance on each version.

PS3D effects may be applied selectively to any kind of visual information displayed by a data processing system via 3D display technology. As a general point, it will be understood that selected elements of the content of any document or other display content can be stereoscopically displayed without any need to modify the original document or other source data, simply by changing the relative horizontal positions of items on the “page” in one (right or left) or both views. No change in the format of the source data is required. By way of illustration and non-limiting example, the following may be considered:

Simple Document

In the present context, a “simple document” as displayed on a visual display may be understood to correspond to a conventional printed document, with essentially static content, typically encoded in a single data file. A typical document of this kind may be a word processor document (e.g. MS Word), spreadsheet (e.g. MS Excel), presentation (e.g. MS PowerPoint), a PDF document, HTML or mHTML document or the like and will include elements having different attributes; e.g. different text formatting applied to different hierarchical heading levels, numbered lists etc. In this context an “item” as referred to herein may simply be a text string having particular attributes, or any other kinds of object such as are commonly found in digital documents.

Example style rules that may be applied to the display of a document, without any need for modification of the source document, may include applying PS3D effects to headings in a text document, italic text, bold text, hypertext, images with borders, images without borders, etc. In HTML documents and the like, document style rules are defined explicitly as tags which can be reflected into data objects and parameters used for applying PS3D effects to objects; e.g.

<b>bold text</b>
<i>italic text</i>
<a href=“”>hyperlink</a>

Typically, different z-axis displacements may be applied to elements having different “styles”.

A document or data file format in accordance with one aspect of the invention provides for the inclusion, within the document file, of explicit definitions of PS3D effects to be applied when the document is displayed. The PS3D effects may be applied to individual objects or data within the document file. The definitions within the document may fully define a PS3D effect or may provide a pointer to a particular PS3D rule or effect that is defined externally of the document. For example, a data processing system may define a set of 3D rules and the document simply includes specific references to particular ones of those rules. Alternatively or additionally, the data processing system may be capable of interpreting and applying specific PS3D effects that are included in the document file. A PS3D effect that is defined within a document in relation to a particular object may over-ride, or be over-ridden by, or augment a PS3D rule that is defined externally of the document for objects of that type or on the basis of other parameters associated with the object or its display relationship to other objects/display items.

As an example of the above, “PS3D tags” may be defined as an extension to a markup language, or PS3D styling properties defined as an extension to styling properties which determine the 2D presentation of documents. These PS3D tags or properties may be interpreted by a system as described herein to enrich a conventional 2D document with stereoscopic effects.

In one aspect, the present invention provides for an application program for authoring documents that include such definitions of PS3D effects, and add-ons or plug-ins or the like for existing application programs to enable the inclusion of such definitions in documents authored using the existing application program. Whilst “PS3D tags” could be inserted into, for example, an HTML document by manual editing of the HTML code, it can be seen that an authoring or editing application may enable document objects to be selected and 3D effects applied by means of interactive tools that allow the z-displacement (and other effects parameters, if applicable) of the selected object to be adjusted visually, and that such tools may allow for a selected effect to be applied to some or all objects of a similar type or having some other property or properties in common. The same applies to applications for authoring or editing other types of documents etc. as discussed below and for developing sets of 3D effects rules.

The document or data file format containing PS3D properties generated by such application programs may be an extension of an existing file format. The file format with PS3D effects may be constructed in such a way as to be compatible with an existing application program capable of interpreting and displaying the document in 2D without the additional PS3D effects.

Complex Document with Metadata

In the present context, a “complex document” may be understood to be a collection of document content which contains metadata that is not directly related to the appearance of the document on a visual display. The same considerations that apply to simple documents may apply equally to complex documents, but the metadata of complex documents lends itself to further possibilities. For example, the relative z-axis prominence of objects within such a display may be determined by factors such as sponsorship/advertising, popularity among a network user community, history of selection/use by an individual user, etc

By way of example, a search engine interface may return a list of search results, which may include sponsored results. PS3D effects may be applied to sponsored results to give them greater visual prominence over other results. Such PS3D effects may be dynamic in nature as discussed elsewhere in the present application. Z-axis displacement may also be used to indicate ranking of search results: instead of indicating ranking by the order in which the results are displayed, the results may be ordered, for example, alphabetically, with relative rankings being indicated by z-axis prominence.

By way of further example, particular areas within a web page may be reserved for advertising content, such areas being given differing z-axis prominence depending on the cost of the advertising space.

An object-based system of the type previously described may be extended to allow the selective application of PS3D effects via rules which incorporate metadata. The metadata component of the information may be associated either with document objects within the object-based representation, or with the data objects comprising the display list, or with both according to the design of the data processing system. The 3D effects rules module of the preferred embodiments interacts at the level of the rendering system and display list. The same arrangement may thus be employed to incorporate the metadata when the data objects themselves have handles or pointers to the metadata, and also when the metadata is retained at the document object representation because the system may be designed to hold pointers between the data objects of the display list and a corresponding document object. The example of Appendices 1 and 2 illustrates one method of implementing such a linkage via the ‘Edr ptr’ address. Other methods may be used by the skilled person to achieve the same goal of associating metadata with the data objects so that the 3D effects rules may then be extended to incorporate metadata.

An example of such extended 3D effects rules is shown in FIG. 8, rules R11 to R19. This set of rules would give 3D prominence to advertisements, sponsored search results, sponsored hyperlinks and links to pages that are included in a favourites list. The same set of rules can apply graduated 3D effects to a list of items with metadata relating to popularity, with popular items brought forward in the 3D display and less popular items pushed behind. Similarly a set of thumbnail images used to bookmark pages could be ordered in 3D space based on metadata which describes the viewing history.

Metadata associated with a data object may comprise, by way of non-limiting example, one or more of metadata indicating a comment, edit, tracking change, date, time, email address, phone number, footnotes, or content from a master page of a presentation file.

User Interface Events

A data processing system will typically respond to user interface events, which are events generated by user interaction through an external device such as a mouse, keyboard, touchscreen or similar. The events may be generated by the operating environment, as happens with virtually all GUI programs. An event generally has coordinates which indicate the location where the event occurred relative to a screen coordinate system, and an event type associated with it (e.g. click, drag, double click etc). An Event Handling Module within the data processing system maps the event's coordinates onto the positional information contained within the display list, to associate the event with a particular object. It then checks the event handlers for this object to see if it recognises an event of this type.

Such user interface events can include, without limitation;
Focus-in and Focus-out, when for instance a pointing device is moved onto or away from an object or by tabbing navigation towards or away from the object.
Mouse events such as click, mousedown, mouseup, mouseover etc

The system of the present invention may be extended to apply PS3D effects selectively to display items on receipt of a user interface event. For example, PS3D highlighting may be applied to desktop icons when selected, to a menu or list item which has focus, or to an image when the mouse pointer is over it. An example of extended 3D effects rules which incorporate user interface events is shown in FIG. 9, rules R21 to R26.

GUI Environment

Relevant data objects to which 3D effects can be applied include GUI objects. For such GUI objects, relevant 3D effects rules may be defined within the graphical user interface system of the data-processing system. As a particular case, the present invention may be utilised to enhance a two dimensional graphical user interface (GUI) with stereoscopic 3D effects.

A GUI system generally provides ‘windows’ meaning an area of the screen controlled by an application. Windows can contain other windows, as well as GUI ‘controls’ or ‘widgets’ which can be manipulated by the user or application program. Common examples of such controls include labels, buttons, menus, list-boxes, text entry and other controls that are well known in the art.

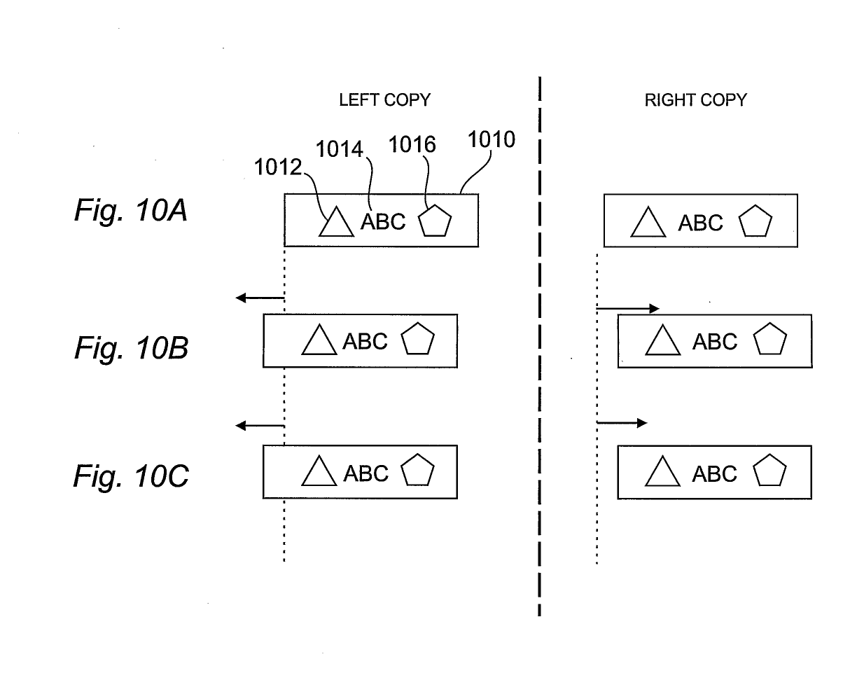

The treatment of windows, or other composite objects which act as containers for further objects, may be seen with reference to FIG. 10. In this example a window 1010 contains three further nested objects comprising a triangle 1012, a text block 1014 and a pentagon 1016. In a windowing system the position coordinates of these nested objects are specified relative to the origin of the window. This allows the window to be moved in two dimensions whilst retaining the relative positions of the nested objects within the window display, independently of the position of the window itself.

In a preferred embodiment of the invention as applied to a GUI system, the window is a composite data object with a set of position coordinates defining the location of the window, for example its top left corner, within the system coordinate space. The nested objects contained within the window have position coordinates that are specified relative to the window origin, which may differ from the system origin. Such a scheme may be applied to any composite data objects which comprise a set of nested data objects that collectively define a composite 2D display item, which in turn comprises multiple 2D display elements.

As illustrated in FIG. 10, a PS3D effect may be uniformly applied to an entire window and all of its nested contents simply by specifying a lateral offset to the position coordinates of the window object itself. This is shown in FIG. 10B, in which the positions of the nested objects relative to the window origin do not change i.e. no further lateral offset is applied to the nested objects. The visual effect of this rule is that the window and its entire contents is displaced on the Z-direction by a uniform planar amount. FIG. 10C further illustrates that by also applying a lateral offset to selected objects within the window, a further Z-displacement may be given to these selected objects relative to the plane of the displaced window object.

In a GUI system the term child windows is used to mean windows that are opened either automatically or as a result of some user activity when using a parent window. They can range in functionality from the very simple to the full complement of window controls provided by the GUI system. Message windows, also referred to as dialog boxes or pop-up messages are a type of child window. A dialog box is usually a small and very basic window that is opened by a program or by the operating system in response to a program event or a system event. Their purpose is often to provide information to the user and/or obtain information (or at least a response) from the user, including setting options or issuing commands. They usually lack most of the functionality of the more general types of windows (e.g., the ability to scroll) and in some cases have buttons that must be pushed before other computer functions or programs can be resumed.

Examples of system events that may lead to the addition of a message window within the graphical user interface are well known in the art and may include:
An event raised by the filing system in response to a file save instruction (which may open a dialog presenting a view of the filing system locations available to store the file)
An alert (for example a warning message about system memory)
A confirmation dialog (for example seeking confirmation that an item is to be deleted)

In a similar way, application programs may make use of the functionality provided by the GUI to raise child or message windows in response to events within the program. For example, a Calendar program may raise an event with a reminder ten minutes in advance of a scheduled calendar entry, and use the GUI system to present this reminder as a dialog window in response to the event.

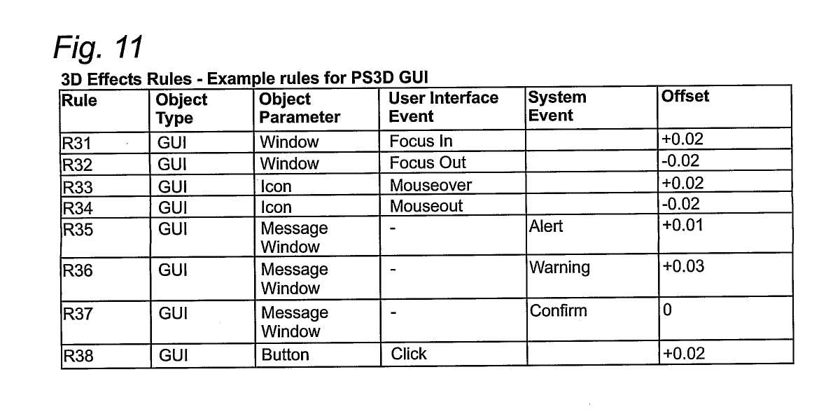

The 3D effects rules described above may be further extended to incorporate relationships on GUI objects that are activated by an associated system event or program event. FIG. 11 shows an example of 3D effects rules for a graphical user interface system, Rules R31-R38, which take account of GUI objects, parameters, user interface events and system/program events within the relationships.

When applied to a two-dimensional GUI system, the present invention therefore allows the elements that comprise the user interface to selectively exhibit PS3D appearance. The 3D effects rules module in such an implementation will have exposure to the various data object types, parameters and events that make up the two-dimensional GUI, such as windows, UI controls, menus and events. Since the system builds on the existing rendering system of the two-dimensional GUI, it retains the ability to manipulate and interact with the graphical user interface for example by moving and resizing windows, scrolling and opening new windows etc.

The implementation of 3D effects rules as disclosed herein in a two-dimensional GUI system has the potential to provide a novel class of user interface with superior ease-of-use and visual richness. PS3D effects can be applied in various ways to different GUI objects. For example:
Windows and other objects such as dialog boxes and pop-up message boxes may be made to appear to float above a GUI desktop when active, and/or inactive windows/objects may be made to appear to recede from the viewer (more generally, z-displacements may be applied corresponding to the stacking order of windows and/or other objects).
Desktop icons, may be PS3D-highlighted when selected, and/or the z-axis prominence of icons may depend on their history of use.
Menus may be PS3D-highlighted when opened, with increasing z-axis prominence for successive hierarchical menu levels and/or selected menu items.
Generally, PS3D effects may be applied to relevant objects in response to user input and/or system events.

The display of a pointer or cursor that tracks movements of a pointing device such as a mouse may also be subject to PS3D effects, the pointer itself constituting a display item in the GUI environment. For example, the pointer may be displayed with a z-axis displacement that is related to the z-axis displacement of an underlying display item (e.g. equal to, or slightly greater or less than, that of the underlying display item).

The invention may be embodied solely to apply PS3D effects to GUI objects, and omit any PS3D effects on non-GUI content. Such a scheme would for example allow windows, icons, menus, dialogs etc to have a PS3D appearance, but the content display items of a window other than the GUI objects themselves would be ‘flat’ in the sense that there is no further relative displacement among these display items. Alternatively, the present invention may be embodied with appropriate 3D effects rules so as to provide PS3D effects both on GUI objects and also on non-GUI objects such as the content of a GUI window.

Application Programs

Many of the same considerations that apply to GUI environments may apply equally to application environments. Additionally, PS3D effects may be applied in similar ways to application-specific elements such as toolboxes and palettes. Application functions may also exploit PS3D effects; e.g. selections may be PS3D-highlighted or PS3D effects may be applied to documents, presentations etc. created by means of the application.

Other examples of applications that may be designed or modified to include or exploit PS3D functionality include stereoscopic image viewers, slide shows and screensavers, enabling original 2D material to be displayed with 3D effects applied thereto.

The use of program events in conjunction with GUI has been described above in the context of applying PS3D effects to GUI objects such as dialog boxes that are activated in response to program events. It is also possible to specify 3D effects rules incorporating program events which have a wider relationship to other types of data object. As an example, an Email or messaging program on a handheld computer may respond to an incoming message event by updating a program display to populate brief details of the new message into the display. Such techniques are well known in the art, and the new message is often highlighted using some kind of two-dimensional display technique.

The present invention may be employed to apply an additional PS3D effect to such a program event. In the example given, the program requests a display update with a new display list containing the data object(s) created in response to the event (for example textual summary of the message sender). The new data object may be highlighted in 3D by firstly including a parameter, event or metadata on the data object which is accessible from the display list, either directly included or via a pointer. The inclusion of this parameter, event or metadata signifies that the data object is associated with a program event of the particular type. A 3D effect rule may then be entered in the rules module to specify a relationship between a selected PS3D effect and the data object's parameter, event or metadata signifying the event.

PS3D Effects with Zoom

The embodiment of the invention as described above applies a lateral offset to the X-position coordinate of the data object in the display list, as shown for example in Table 2. As shown in FIG. 6, the items in the display list are generally subject to a transform prior to final presentation as display items on the display. The transform takes account of the coordinate space conversion between the coordinate space of the display list and the screen coordinates. The transform also takes account of any scale factors to be applied which change the size of the display item. The coordinates and other parameters of the display list are based on a scale size of unity, and the rendered size of the display item may be varied by application of a scale factor contained in the transform.

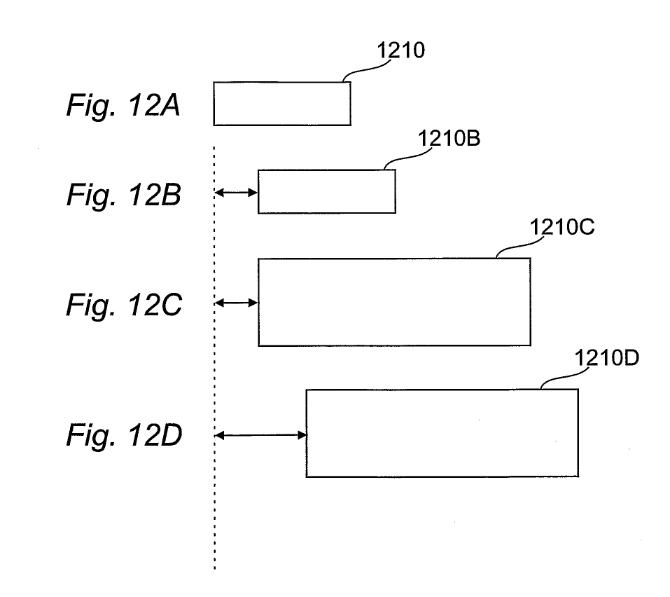

Alternative embodiments of the invention may take different approaches to the treatment of the lateral offset associated with the PS3D effect when applying a transform, as illustrated in FIG. 12. A display item 1210, at unity scale, is shown in FIG. 12A in its screen location prior to applying any offset. FIG. 12B shows the display item 1210B as rendered in the left-eye copy of the display after applying a positive lateral offset associated with the desired PS3D effect. In this case there is no scale transform and the display item is rendered at unity scale so has the same size as the original of FIG. 12A.

FIGS. 12C and 12D show the same display item after applying a scale factor transform to double its size. This may be the result for example of a zoom command within the data processing system to zoom to 200%. FIGS. 12C and 12D illustrate two alternative embodiments of the invention for responding to such zoom or scale commands. In 12C, the transform is applied to the display item 1210C to double its rendered size, but the lateral offset is not adjusted from the physical amount specified via the effects rules. In FIG. 12D, the display item 1210D is once again doubled in size according to the scale transform, and in addition the lateral offset applied to the scaled item is also adjusted. In this latter embodiment, the adjustment will generally be an increase in the offset when the size of the display item increases, however it is not necessarily a linear adjustment in line with the scale factor. Other non-linear adjustment profiles may be employed, and in particular it is preferable to take into consideration the inability of the human eye to recognise a stereoscopic effect when the left and right eye separation becomes too large, so that a limiting adjustment may be imposed.

In the first case as illustrated in FIG. 12C, a display item having a PS3D effect may be zoomed and will increase in size but the apparent displacement of the item in the perpendicular screen direction will be constant. In the second case as in FIG. 12D, the apparent displacement perpendicular to the screen will change as the item's size changes. The choice of effect to be employed is a matter of system design.

The scale at which the item is displayed might also be varied with its z-axis displacement; e.g. increasing in size with positive z-axis displacement towards the viewer and decreasing in size with negative z-axis displacement away from the viewer. In terms of the present disclosure, object types, properties and conditions are all parameters associated with an object. Particular rules may further specify a scaling factor by which the scale at which an item is displayed is varied along with its z-displacement. This may be accomplished by extending the 3D effects rules to include a scale transform in addition to the lateral offset to be applied to the data objects which fulfil the criteria of a particular rule. The scale transform is preferably in the format understood by the two dimensional rendering system, which already has the capability to scale the size of any display item according to the transform provided with the data object. The scale transform applied via the 3D effects rules would be applied in addition to any transforms already attached to the object through the regular two-dimensional system. In this way a separate scaling factor may be applied in conjunction with the z-axis displacement to give the appearance of an item growing out of or shrinking away from the page.

PS3D Controls/Tools

Provision may be made within operating systems and/or GUIs and/or application programs for users to switch PS3D effects on and off entirely or on a selective basis, and to create or customise PS3D rules.

Further, a user may be presented with interactive tools or controls for controlling PS3D effects. For example, an on-screen slider control could be used to vary the z-axis displacement of items, selectively or globally within a particular display view or within an application or GUI environment. A physical control such as a scroll-wheel of a mouse, a scroll/slider zone of a touchpad or directional control keys of a keyboard or keypad may also be used to control z-axis displacement of display items, particularly an item underlying the pointer. The operation of such controls may be automatic or context-sensitive, or may be enabled or disabled at the option of the user.

User-operable controls and tools of these types may operate simply by varying the offset values specified in the 3D effects rules, for example in increments or according to a variable multiplication factor, so as to increase or decrease the apparent z-displacements applied to display items. A “global” PS3D effect control may be particularly desirable or useful in a PS3D GUI environment, allowing a user to adjust the degree of z-displacement to suit personal taste or utility requirements. Instead of varying offset values by simple increments or multiplication factors, more complex adjustments might be applied; for example, an exponential or proportional variation, or the like, might be applied such that display items that are relatively further displaced from the display plane have their offsets varied by smaller amounts than items that are relatively closer to the display plane, so as to constrain extreme variations that might cause undesirable visual effects.

### Additional Aspects and Features of Preferred Embodiments of the Invention

PS3D effects may be applied or maintained when certain actions are performed, such as zooming or panning a view of a document or the like.

PS3D effects may also be applied based on the position of a pointer or cursor (including fingers or styli in the case of touch sensitive screens); e.g. the effects may be applied to objects in proximity to the pointer position.

When and how the PS3D left- and right-eye copies are generated will depend at least in part on the nature of the data processing system of which the display forms a part and on the nature and purpose of the PS3D effects. It is particularly preferred that the PS3D copies are generated by an object-based rendering engine of the type referred to above, such that the PS3D copies may be generated directly by the rendering engine and need only be generated immediately prior to final screen rendering. This provides maximum flexibility in allowing PS3D effects to be determined or affected by any inputs or events prior to rendering and places the least processing burden on the system upstream of and within the rendering engine. It is further preferred that the PS3D copies should not need to be defined explicitly in the source data from which the display objects are derived, since this requires that the objects always be created with specific PS3D effects in mind and places the greatest burden on the system processing the source data.

The specific application of the 3D effects rules to particular objects is based on parameters associated with the data objects. Relevant data object parameters may include at least one parameter having a value that can vary between data objects that are otherwise similar (e.g. size, orientation, screen location) and the relationships specified in the 3D effects rules can be based at least in part on at least one value of at least one of said parameters.

Further, the relationships specified in the 3D effects rules may be based at least in part on relative values of parameters of two or more respective data objects.

Relevant data object parameters may further include at least one parameter having a value that is based at least in part on relative Z-ordering of two or more corresponding 2D display items (e.g. the stacking order of overlapping windows).

Data objects to which 3D effects rules may be applied include composite data objects. Such composite data objects may comprise a set of nested data objects that collectively define a composite 2D display item, that in turn comprises multiple 2D display elements. In such cases, lateral offsets for stereoscopic display of the composite display item may be defined on the basis of the relative 2D locations of said 2D display elements within said composite 2D display item; i.e. independently of the actual 2D screen location of the composite 2D display item itself.

Relevant stereoscopic 3D effects may be dynamic effects having 3D effects parameters that vary with time. For this purpose, the offsets applied to the left- and right-eye views of the display item may vary progressively in a succession of screen refreshes. This may provide the basis for a wide variety of dynamic visual effects. In a simple example, a display item might be made to appear to move backwards and forwards along the z-axis before coming to rest at some position along the z-axis. More complex examples may include movements of the display item in the X/Y plane and/or rotations of the item about one or more axes and/or changes of scale and/or visual distortions of the item.

As previously mentioned, one of the first and second rendered positions of the 2D display item may be at the 2D screen location as defined without reference to the 3D effects rules and the other of the first and second rendered positions may be at a screen location offset laterally from said 2D screen location. This provides a visible stereoscopic effect with minimal processing burden. Alternatively, both of the first and second rendered positions of the 2D display item may be at respective screen locations offset laterally in opposite directions from the 2D screen location.

In certain preferred embodiments, one or more 3D effects rules may be provided that specify a relationship between particular locations and a particular stereoscopic 3D effect or type of 3D stereoscopic effect, such that 2D display items may be selected having 2D locations that correspond to the particular locations specified in the 3D effects rules. In this context the locations as described in the preceding sentence may refer to one or more of: the position coordinates of a data object within the coordinate space of the display list; the screen location of a display item on the display; and the relative 2D screen locations of display items.

By way of example, particular areas within a web page may be reserved for advertising content, such areas being given differing z-axis prominence and/or particular dynamic 3D effects depending on the cost of the advertising space.

In certain further embodiments, one or more 3D effects rules may be provided that specify a relationship between display items having a particular size and a selected stereoscopic 3D effect or type of 3D stereoscopic effect such that 2D display items may be selected having a size that corresponds to the particular size.

Further aspects of the invention apply, at least in certain applications, to 3D content in which 3D effects are obtained by means other than the presently described PS3D effects (e.g. where the display content includes “genuine” 3D content such as stereoscopic images or video). 3D effects may be incorporated into various kinds of transitions between display views (zooms, morphing, tumbling of objects etc.), based on the content of the respective views. Objects passing in front of/behind one another may have appropriate z-axis displacements applied.

Where a transition from one 3D view to another involves the generation of intermediate views between a start view and an end view, the intermediate views may be presented in 3D and may be presented at reduced resolution relative to the start or end views.

The data object parameters relevant to the application of 3D effects rules will typically include a data object type. The relationships between data object parameters and particular 3D effects specified in the 3D effects rules may be based at least in part on the type of data object. Relevant data object types may include, without limitation, any one or more of various data object types discussed above.

Relevant data object parameters may include at least one parameter having a value that can vary between data objects that are otherwise similar (e.g. size, orientation, screen location) and the relationships specified in the 3D effects rules can be based at least in part on at least one value of at least one of said parameters.

Relevant data object parameters may further include:
a style associated with a data object (e.g. for text objects, font, font size, bold, italic, underlined, alignment, justification);
markup language tags.

Relevant data object parameters may further include at least one parameter having a value that is based at least in part on further data (e.g. metadata) associated with respective data object. Such further data includes, by way of non-limiting example, history of usage, popularity or sponsorship of a display item or of data corresponding to a display item (e.g. a media file corresponding to an icon).

Relevant data objects include GUI objects. For such GUI objects, relevant 3D effects rules may be defined within the graphical user interface system of the data-processing system.

Generally speaking, the 3D effects rules may specify applying further lateral offsets in the X-direction and/or vertical offsets in the Y-direction of the X/Y display plane, to be applied to first and second rendered positions of the 2D display items. Such further offsets provide stereoscopic effects that include the corresponding display item being perceived by the viewer as being displaced in the X- and/or Y-direction in addition to being displaced along the z-axis.

An existing application program, rendering system or operating system without any PS3D functionality may be modified to include such functionality, e.g. by means of plug-ins or the like.

It is known, particularly but not exclusively in relation to web page content, for display content to be changed in response to a pointer or cursor being moved over a particular screen area (commonly referred to as “rollover” or “mouseover” effect). For example, pointing to an image or other display item may cause an enlarged version of the image, or of different content, to be displayed (“zoom rollover”) or to fade in or out (“fading rollover”) or may cause a change to another part of the display area (“disjointed rollover”). PS3D effects may be applied to any display content that has been set up with rollover/mouseover effects; e.g. whatever content is to be displayed in response to a rollover event may be displayed as displaced forwards along the z-axis.

In terms of the present disclosure, object types, properties and conditions are all parameters associated with an object. Particular rules may further specify a scaling factor by which the scale at which an item is displayed is varied along with its z-displacement.

The implementation of PS3D effects requires that, at some point prior to rendering a display:
A determination is made as to what effects are to be applied to which items within the display, on the basis of 3D effects rules applied to data objects corresponding to display items.
The required PS3D copies of the relevant items are generated for rendering in the display (including multiple copies as may be required for autostereoscopic display technologies).

The determination of the effects to be applied may be done on the basis of any of the criteria discussed above.

A typical data processing system in which the PS3D effects are implemented will include a rendering system of some type that processes data objects in order to define the content of visual display frames that are stored in one or more frame buffers (or similar or equivalent display memory), and hence to determine the display content at any given time. The content of the frame buffer(s) includes the content of each of the left and right eye display views that are to be displayed via the applicable 3D display technology. Typically, the content of the frame buffer(s) is rendered into a screen buffer of the display device.

As for conventional 2D rendering, the rendering system may receive data objects from a variety of sources within the data processing system, including, for example, application programs, operating system, GUI and windowing system. In one embodiment the rendering system processes a set of data objects in a display list. The display list specifies the positions at which particular items are to be displayed. The display list is processed so as to render representations of the data objects into the frame buffer(s).

For the purposes of the presently described 3D effects, the rendering engine further operates to apply 3D effects rules to objects as they are processed through the display list. In particular, in a preferred embodiment, the rendering system applies the 3D effects rules so as to specify differing (laterally offset) screen locations for left and right eye views of items that are to be displayed with a z-displacement.

For relatively straightforward effects rules, applicable, say, to specific object types and intrinsic parameters of object instances, the rules may comprise a simple look-up table of object types and/or associated parameter conditions, and corresponding offsets (or formulae for determining offsets) to be applied. When processing individual objects the rendering system, or a 3D effects module within or associated with the rendering system, may simply consult the look-up table to determine what 3D effect(s), if any, are applicable to that object.

More complex rules, whose application might depend for example on the relationships between two or more objects or the occurrence of system events or user input, may require more sophisticated interaction between the rendering system and the 3D effects module and/or 3D effects rules module. The data defining the rules may have a hierarchical or multi-dimensional structure, and the determination of applicable effects may require calculations involving, for example, the screen locations of multiple objects and/or parameters extrinsic to the objects themselves, including metadata, system event data or user input data.

3D effects may be provided as an add-on to a pre-existing rendering system, by providing the 3D effects module as an additional processing stage that cooperates with the rendering engine; i.e. data objects and any other data relevant to the application of the 3D effects rules that would otherwise have been processed by the rendering engine are subject to additional processing by the 3D effects module such that the output from the rendering engine is suitable for driving the relevant 3D display so as to include the required 3D effects.

In a further alternative, multiple 3D effects modules may be provided for selective deployment in a data processing system. Application-specific modules may be deployed that cooperate with input to the rendering system from particular applications, so as to apply 3D effects to the display output from those applications. For example, the output from a web-browser may have 3D effects applied. Similarly, a GUI-specific module may be deployed that cooperates with the GUI and the rendering engine to apply 3D effects to GUI objects.

Alternatively or additionally, the 3D effects rules and other functions of the 3D module may be integrated into the general “rendering rules” of a purpose-built rendering engine, and applied to objects as an integral part of the rendering process.

Broadly speaking, the application of the 3D effects rules may be viewed as an extension of conventional 2D rendering rules whereby data objects are processed in order to display corresponding items at particular screen locations, with appropriate overlapping of items and with relevant visual effects such as highlighting to indicate selection etc. That is, the 3D effects rules operate to modify or augment the conventional 2D display rules such that the rendering engine generates left and right eye copies of the display items for rendering in respective left and right eye views of the display.

However the 3D effects rules are implemented, the result as far as the rendering system is concerned will be to define the screen locations of all objects for the respective left and right eye views of the stereoscopic display, such that the various objects are displayed with z-displacements as specified by the 3D effects rules. Of course, left and right eye copies are required even for objects that are to be displayed with zero z-displacement, but the screen locations of such objects will be identical in both the left and right eye views; i.e. no lateral offsets are applied to such objects.

It will be understood that final screen rendering of the display may be accomplished by conventional techniques such as rasterisation, scanline rendering, tile rendering etc., as appropriate to the particular display technology in use.

It can be seen that the methods of the present invention have the effect of transforming 2D display items as they would otherwise appear on a visual display into stereoscopic display items for display via a stereoscopic visual display.

Persons skilled in the relevant arts will be able to apply or implement methods, systems etc. in accordance with the various aspects of the present invention on the basis of the teaching provided herein

Improvements and modifications may be incorporated without departing from the scope of the invention.

APPENDIX 1
Display list for sample document (FIG. 2)

| | |
|---|---|
| 1 | |
| 2 | |
| 3 | doc = 1eb1dac, page list = 1ef04ac |
| 4 | ********************************************************************** |
| 5 | Section 0, page 0 at 1ef04ac |
| 6 | Container at 1ef13c4, sized (0.00, −11.00) -> (2.26, 0.00) |
| 7 | [doc 1eb1dac, section 0, page 0, bitmap 1eb18ec] |
| 8 | background color: ff,ff,ff/ff |
| 9 | clipping region: none |
| 10 | Box object ptr: 1eb10d8, Edr ptr: 0, parent: 0:: |
| 11 | Position (0.00,−11.00) Bounding box (0.00, 0.00)-(2.26, 11.00) |
| 12 | fill color ff,ff,ff/ff |
| 13 | left : border 0.00 (col 00,00,00/ff, stroke 0) |
| 14 | top : border 0.00 (col 00,00,00/ff, stroke 0) |
| 15 | right : border 0.00 (col 00,00,00/ff, stroke 0) |
| 16 | bottom: border 0.00 (col 00,00,00/ff, stroke 0) |
| 17 | Box object ptr: 1ef2778, Edr ptr: 1ef1da4, parent: 0 :: |
| 18 | Position (0.04,−3.97) Bounding box (0.00, 0.00)-(2.19, 2.21) |
| 19 | fill color 00,00,00/00 |
| 20 | left : border 0.00 (col 00,00,00/ff, stroke 0) |
| 21 | top : border 0.00 (col 00,00,00/ff, stroke 0) |
| 22 | right : border 0.00 (col 00,00,00/ff, stroke 0) |
| 23 | bottom: border 0.00 (col 00,00,00/ff, stroke 0) |
| 24 | Box object ptr: 1ef0df0, Edr ptr: 1ef1820, parent: 0:: |
| 25 | Position (0.04,−1.68) Bounding box (0.00, 0.00)-(2.19, 0.35) |
| 26 | fill color 00,00,00/00 |
| 27 | left : border 0.00 (col 00,00,00/ff, stroke 0) |
| 28 | top : border 0.00 (col 00,00,00/ff, stroke 0) |
| 29 | right : border 0.00 (col 00,00,00/ff, stroke 0) |
| 30 | bottom: border 0.00 (col 00,00,00/ff, stroke 0) |
| 31 | Box object ptr: 1ef8174, Edr ptr: 1ef1118, parent: 0:: |
| 32 | Position (0.04,−1.25) Bounding box (0.00, 0.00)-(2.19, 0.17) |
| 33 | fill color 00,00,00/00 |
| 34 | left : border 0.00 (col 00,00,00/ff, stroke 0) |
| 35 | top : border 0.00 (col 00,00,00/ff, stroke 0) |
| 36 | right : border 0.00 (col 00,00,00/ff, stroke 0) |
| 37 | bottom: border 0.00 (col 00,00,00/ff, stroke 0) |
| 38 | Box object ptr: 1ef0d68, Edr ptr: 1ef11ec, parent: 0:: |
| 39 | Position (0.04,−0.99) Bounding box (0.00, 0.00)-(2.19, 0.20) |
| 40 | fill color 00,00,00/00 |
| 41 | left : border 0.00 (col 00,00,00/ff, stroke 0) |
| 42 | top : border 0.00 (col 00,00,00/ff, stroke 0) |
| 43 | right : border 0.00 (col 00,00,00/ff, stroke 0) |
| 44 | bottom: border 0.00 (col 00,00,00/ff, stroke 0) |
| 45 | Box object ptr: 1eec448, Edr ptr: 1ef2044, parent: 1ef2778 :: |
| 46 | Position (0.04,−3.93) Bounding box (0.00, 0.00)-(1.14, 1.08) |
| 47 | fill color 00,00,00/00 |
| 48 | left : border 0.00 (col ff,ff,ff/ff, stroke 0) |
| 49 | top : border 0.00 (col ff,ff,ff/ff, stroke 0) |
| 50 | right : border 0.00 (col ff,ff,ff/ff, stroke 0) |
| 51 | bottom: border 0.00 (col ff,ff,ff/ff, stroke 0) |
| 52 | Text object ptr: 1ef26ec, Edr ptr: 1ef147c, parent: 1ef0d68 :: |
| 53 | Position (0.04,−0.93) Bounding box (0.00, −0.06)-(0.52, 0.15) |
| 54 | font: size=11.13, style=Normal, weight=700, variant=Normal |
| 55 | mode: Kerning |
| 56 | spacing: letter=0.00, word=0.00 |
| 57 | colour: 00,00,00/ff |
| 58 | string: len=6, ‘Header’ |
| 59 | Text object (hidden) ptr: 1ef2b68, Edr ptr: 1ef16c8, parent: 1ef8174 :: |
| 60 | Position (0.04,−1.21) Bounding box (0.00, −0.04)-(0.04, 0.13) |
| 61 | font: size=10.25, style=Normal, weight=400, variant=Normal |
| 62 | mode: Kerning |
| 63 | spacing: letter=0.00, word=0.00 |
| 64 | colour: 00,00,00/ff |
| 65 | string: len=1, ‘<A0>’ |
| 66 | Text object ptr: 1ef28b0, Edr ptr: 1ef18a4, parent: 1ef0df0 :: |
| 67 | Position (0.04,−1.46) Bounding box (0.00, −0.04)-(0.78, 0.13) |
| 68 | font: size=10.25, style=Normal, weight=400, variant=Normal |
| 69 | mode: Kerning |
| 70 | spacing: letter=0.00, word=0.00 |
| 71 | colour: 00,00,00/ff |
| 72 | string: len=15, ‘Text text text ’ |
| 73 | Text object ptr: 1ef7a64, Edr ptr: 1ef19fc, parent: 1ef0df0 :: |
| 74 | Position (0.82,−1.46) Bounding box (0.00, −0.04)-(0.27, 0.13) |
| 75 | font: size=10.25, style=Normal, weight=700, variant=Normal |
| 76 | mode: Kerning |
| 77 | spacing: letter=0.00, word=0.00 |
| 78 | colour: 00,00,00/ff |
| 79 | string: len=4, ‘bold’ |
| 80 | Text object ptr: 1ee8114, Edr ptr: 1ef1b60, parent: 1ef0df0 :: |
| 81 | Position (1.09,−1.46) Bounding box (0.00, −0.04)-(0.53, 0.13) |
| 82 | font: size=10.25, style=Normal, weight=400, variant=Normal |
| 83 | mode: Kerning |
| 84 | spacing: letter=0.00, word=0.00 |
| 85 | colour: 00,00,00/ff |
| 86 | string: len=11, ‘ text text ’ |
| 87 | Text object ptr: 1eec040, Edr ptr: 1ef1be8, parent: 1ef0df0 :: |
| 88 | Position (1.62,−1.46) Bounding box (0.00, −0.04)-(0.29, 0.13) |
| 89 | font: size=10.25, style=Italic, weight=400, variant=Normal |
| 90 | mode: Kerning |
| 91 | spacing: letter=0.00, word=0.00 |
| 92 | colour: 00,00,00/ff |
| 93 | string: len=6, ‘italic’ |
| 94 | Text object ptr: 1eec0cc, Edr ptr: 1ef1d50, parent: 1ef0df0 :: |
| 95 | Position (1.92,−1.46) Bounding box (0.00, −0.04)-(0.25, 0.13) |
| 96 | font: size=10.25, style=Normal, weight=400, variant=Normal |
| 97 | mode: Kerning |
| 98 | spacing: letter=0.00, word=0.00 |
| 99 | colour: 00,00,00/ff |
| 100 | string: len=5, ‘ text’ |
| 101 | Text object ptr: 1eec13c, Edr ptr: 1ef1d50, parent: 1ef0df0 :: |
| 102 | Position (0.04,−1.64) Bounding box (0.00, −0.04)-(0.25, 0.13) |
| 103 | font: size=10.25, style=Normal, weight=400, variant=Normal |
| 104 | mode: Kerning |
| 105 | spacing: letter=0.00, word=0.00 |
| 106 | colour: 00,00,00/ff |
| 107 | string: len=5, ‘text.’ |
| 108 | Path object ptr: 1ef0a34, Edr ptr: 1ef21c0, parent: 1ef2778 :: |
| 109 | Position (0.04,−2.84) Bounding box (0.00, 0.00)-(1.14, 1.08) |
| 110 | fill color ff,ff,ff/ff |
| 111 | Path object ptr: 1ef04dc, Edr ptr: 1ef21c0, parent: 1ef2778 :: |
| 112 | Position (0.04,−2.84) Bounding box (−0.00, −0.00)-(1.14, 1.08) |
| 113 | fill color 00,00,00/ff |
| 114 | ImageUrl object ptr: 1ef0864, Edr ptr: 1ef7d1c, parent: 1eec448 :: |
| 115 | Position (0.04,−3.93) Bounding box (0.00, 0.00)-(1.14, 1.08) |
| 116 | transform a:2.55, b:0.00, c:0.00, d:2.43, x:0.00, y:0.00 |
| 117 | imageurl (null) |
| 118 | colour: 00,00,00/ff |
| 119 | Text object (hidden) ptr: 1ef0a88, Edr ptr: 1ef7ddc, parent: 1ef2778 0 :: |
| 120 | Position (1.17,−3.93) Bounding box (0.00, −0.04)-(0.04, 0.13) |
| 121 | font: size=10.25, style=Normal, weight=400, variant=Normal |
| 122 | mode: Kerning |
| 123 | spacing: letter=0.00, word=0.00 |
| 124 | colour: 00,00,00/ff |
| 125 | string: len=1, ‘<A0>’ |
| 126 | End of Display List |
| 127 | ********************************************************************** |

APPENDIX 2
Object Based Representation for sample document (FIG. 2)

| | |
|---|---|
| 1 | |
| 2 | |
| 3 | ----------------------------------------------------- |
| 4 | Stylesheet 0 1eecba8: |
| 5 | source url: (unset) |
| 6 | origin: Author |
| 7 | document: Display = Block |
| 8 | section: Display = Block, |
| 9 | BackgroundColor = (color = (ff,ff,ff/ff) |
| 10 | paragraph: Display = Block, |
| 11 | EpageTabstopWidth = (len = 0.492355), |
| 12 | WhiteSpace = Wrap |
| 13 | textGroup: FontSize = (len = 0.138885), |
| 14 | FontFamily = (string “Times New Roman”) |
| 15 | textBox: Overflow = Hidden, |
| 16 | Color = (color = (0,0,0/ff), |
| 17 | Display = Block, |
| 18 | EpageTextBoxVerticalAlignment = Top, |
| 19 | TextIndent = (len = 0.000000) |
| 20 | [unknown:19d]: Width = (len = 8.500000), |
| 21 | Height = (len = 11.000000), |
| 22 | MarginLeft = (len = 0.787491), |
| 23 | MarginRight = (len = 0.787491), |
| 24 | MarginTop = (len = 0.787491), |
| 25 | MarginBottom = (len = 0.787491) |
| 26 | [unknown:20d]: EpageLineHeight = (Type = Relative (percent = 100.000000), leading |
| 27 | = (percent = 105.000000) ), |
| 28 | MarginTop = (len = 0.166656), |
| 29 | MarginBottom = (len = 0.083328), |
| 30 | TextAlign = Left, |
| 31 | EpageTabstopOffset = (len = 0.787491), |
| 32 | EpageTabstopArray = (number = 1, (0.000000/List/None)) |
| 33 | [unknown:21d]: FontWeight = Bold, |
| 34 | FontFamily = (string “Arial”), |
| 35 | EpageWordFEFontFamily = (string “MS Mincho”), |
| 36 | FontSize = (len = 0.222214) |
| 37 | [unknown:22d]: EpageLineHeight = (Type = Relative (percent = 100.000000), leading |
| 38 | = (percent = 105.000000) ), |
| 39 | MarginBottom = (len = 0.083328), |
| 40 | TextAlign = Left, |
| 41 | EpageTabstopOffset = (len = 0.787491) |
| 42 | [unknown:23d]: EpageWordFEFontFamily = (string “Times Roman”), |
| 43 | FontSize = (len = 0.166656), |
| 44 | Visibility = Hidden |
| 45 | [unknown:24d]: EpageWordFEFontFamily = (string “Times Roman”), |
| 46 | FontSize = (len = 0.166656) |
| 47 | [unknown:25d]: FontWeight = Bold, |
| 48 | EpageWordFEFontFamily = (string “Times Roman”), |
| 49 | FontSize = (len = 0.166656) |
| 50 | [unknown:26d]: FontStyle = Italic, |
| 51 | EpageWordFEFontFamily = (string “Times Roman”), |
| 52 | FontSize = (len = 0.166656) |
| 53 | [unknown:27d]: EpageImageAnchorHorizontal = Column, |
| 54 | EpageImageAnchorVertical = Paragraph, |
| 55 | Left = (len = 0.477768), |
| 56 | Top = (len = 0.406937), |
| 57 | Width = (len = 1.135422), |
| 58 | Height = (len = 1.081940), |
| 59 | EpageListImageId = (num = 1026) |
| 60 | ----------------------------------------------------- |
| 61 | ===================================================== |
| 62 | |
| 63 | Group,@ 1ea8cc8 refcount = 1 type document (5) |
| 64 | Group,@ 1ef08cc type section (13) styles [unknown:19d] |
| 65 | Group,@ 1ef11ec type paragraph (11) styles [unknown:20d] |
| 66 | Group,@ 1ef1448 type textGroup (19) styles [unknown:21d] |
| 67 | Text,@ 1ef147c ‘Header’ |
| 68 | Group,@ 1ef1118 type paragraph (11) styles [unknown:22d] |
| 69 | Group,@ 1ef1694 type textGroup (19) styles [unknown:23d] |
| 70 | Text,@ 1ef16c8 ‘{A0}’ |
| 71 | Group,@ 1ef1820 type paragraph (11) styles [unknown:22d] |
| 72 | Group,@ 1ef1870 type textGroup (19) styles [unknown:24d] |
| 73 | Text,@ 1ef18a4 ‘Text text text ’ |
| 74 | Group,@ 1ef19c8 type textGroup (19) styles [unknown:25d] |
| 75 | Text,@ 1ef19fc ‘bold’ |
| 76 | Group,@ 1ef1b2c type textGroup (19) styles [unknown:24d] |
| 77 | Text,@ 1ef1b60 ‘ text text ’ |
| 78 | Group,@ 1ef1bb4 type textGroup (19) styles [unknown:26d] |
| 79 | Text,@ 1ef1be8 ‘italic’ |
| 80 | Group,@ 1ef1d1c type textGroup (19) styles [unknown:24d] |
| 81 | Text,@ 1ef1d50 ‘ text text.’ |
| 82 | Group,@ 1ef1da4 type paragraph (11) styles [unknown:22d] |
| 83 | Group,@ 1ef1df4 |
| 84 | Group,@ 1ef1e28 type picture (12) inline:(shared)0002 styles [unknown:27d] |
| 85 | Style,@ 1ef1ff4 EpageWindingRule = NonZero |
| 86 | Style,@ 1ef201c EpageJoinStyle = Round |
| 87 | Style,@ 1ef20f8 EpagePathStyle = FilledAndStroked |
| 88 | Style,@ 1ef2120 Color = (color = (ff,ff,ff/ff) |
| 89 | Style,@ 1ef2148 EpageStrokeColor = (color = (0,0,0/ff) |
| 90 | Style,@ 1ef2170 EpageStrokeWidth = (len = 0.000687) |
| 91 | Style,@ 1ef2198 Position = (_PositionedOrigins 0.000000,1.081940) |
| 92 | Path,@ 1ef21c0 (5 elements)move to (0.000000,0.000000). |
| 93 | line:start=(0.000000,0.000000),end=(1.135422,0.000000). |
| 94 | line:start=(1.135422,0.000000),end=(1.135422,1.081940). |
| 95 | line:start=(1.135422,1.081940),end=(0.000000,1.081940). |
| 96 | close:start=(0.000000,1.081940),end=(0.000000,0.000000). |
| 97 | Style,@ 1ef3114 Position = (_PositionedOrigins 0.000000,0.000000) |
| 98 | Group,@ 1ef2044 inline:(shared)0001 |
| 99 | Group,@ 1ef2078 inline:(shared)0000 |
| 100 | ImageUrl,@ 1ef7d1c (null) |
| 101 | Group,@ 1ef7da8 type textGroup (19) styles [unknown:23d] |
| 102 | Text,@ 1ef7ddc ‘{A0}’ |

1. A data processing system, adapted to process digital documents containing data objects having associated parameters, including a rendering system to render display frames for presentation via a visual display screen, said display frames including 2D display items corresponding to said data objects and each display item having a 2D screen location within the display frame defined by reference to an X/Y display plane;
said rendering system being adapted for rendering left- and right-eye views of the display frames representing said digital documents, the left- and right-eye views of the display frames being rendered by processing the document data objects such that respective left- and right-eye copies of the 2D display items corresponding to said document data objects are included in the left- and right-eye views of the digital documents as presented in said display frames; wherein
stereoscopic 3D effects are applied selectively to those data objects contained within said digital documents having selected parameters, through a set of 3D effects rules that specify relationships between stereoscopic 3D effects and data object parameters, the stereoscopic 3D effects including lateral offsets in the X-direction of said X/Y display plane to be applied when rendering left- and right-eye copies of corresponding 2D display items at respective screen locations, such that 2D display items corresponding to selected data objects within said documents may be perceived by a viewer as being displaced along a Z-axis perpendicular to said X/Y plane.

2. (canceled)

3. A data processing system according to claim 1, wherein the rendering system is adapted to receive the digital documents as source data comprising document files or other data structures representing visual information.

4. A data processing system according to claim 1, wherein the rendering system is adapted to process a display list that defines parameters of a set of data objects corresponding to 2D display items and to process said display list to generate left- and right-eye views of a display frame by applying said 3D effects rules to a set of objects derived from said display list on the basis of the parameters defined by the display list.

5. A data processing system according to claim 1, wherein said data object parameters include a data object type, and said relationships specified in the 3D effects rules are based at least in part on the type of data object.

6. A data processing system according to claim 5, wherein said type of data object is selected from the group consisting of one or more of image object, text object, video object, hyperlink object, advertisement, GUI object, vector graphic object, window object, table object, and animation object.

7. A data processing system according to claim 1, wherein said data object parameters include at least one parameter having a value that may vary between data objects that are otherwise similar and said relationships specified in the 3D effects rules are based at least in part on at least one value of at least one said parameter having a value that may vary.

8. A data processing system according to claim 1, wherein said data object parameters include a style associated with a data object.

9. A data processing system according to claim 1, wherein said data object parameters include a markup language tag.

10. A data processing system according to claim 1, wherein one or more of said 3D effects rules further specify relationships between particular data object parameters, stereoscopic 3D effects and the receipt of user interface events generated by user input targeted at data objects having the particular parameters.

11. (canceled)

12. A data processing system according to claim 1, wherein one or more of said 3D effects rules further specify a relationship between particular data object parameters, a stereoscopic 3D effect and the receipt of a system event occurring in the data processing system.

13. A data processing system according to claim 1, wherein said relationships specified in the 3D effects rules are based at least in part on relative values of parameters of two or more respective data objects.

14. (canceled)

15. A data processing system according to claim 1, wherein said data object parameters include metadata associated with data objects, and one or more of said 3D effects rules further specify a relationship between particular data object parameters, a stereoscopic 3D effect and the metadata associated with respective data object.

16. A data processing system according to claim 15, wherein said metadata associated with a data object relates to one or more of history, popularity or sponsorship metadata.

17. A data processing system according to claim 15, wherein said metadata associated with a data object comprises one or more of metadata indicating a comment, edit, tracking change, date, time, email address, phone number, footnotes, or content from a master page of a presentation file.

18-38. (canceled)

39. A computer-implemented method for applying stereoscopic 3D effects to the display of 2D digital documents containing data objects on a visual display screen in a data processing system that includes a rendering system adapted to process said document data objects to render display frames for presentation via the visual display screen, said display frames including 2D display items corresponding to said document data objects and each display item having a 2D screen location within the display frame defined by reference to an X/Y display plane, a set of 3D effects rules being provided in the data processing system that specify relationships between stereoscopic 3D effects and selected data object parameters associated with the document data objects corresponding to the 2D display items, the stereoscopic 3D effects including lateral offsets to be applied when rendering left- and right-eye copies of display items; the method comprising:
(a) for each of a set of data objects corresponding to display items that are to be rendered in a display frame, determining by reference to the data object parameters and the 3D effects rules whether any 3D effects are to be applied to that data object;
(b) processing the document to generate left- and right-eye copies of the display items, which processing includes applying any lateral offsets specified by any applicable 3D effects rule to the 2D screen locations of the left- and right-eye copies of the display items;
(c) rendering the left- and right-eye copies of the display items into left- and right-eye views of the display such that respective left- and right-eye copies of the display items are included in the left- and right-eye views of the display frames at respective screen locations that are laterally offset in the X-direction of said X/Y display plane in accordance with the 3D effects rules, such that 2D display items corresponding to selected data items within the documents may be perceived by a viewer as being displaced along a Z-axis perpendicular to said X/Y plane.

40. A method according to claim 39, wherein the visual appearance of said display items is determined by processing via the rendering system the data object parameters associated with the data objects corresponding to the 2D display items.

41. (canceled)

42. A method according to claim 39, comprising receiving the digital documents as document files or other data structures representing visual information, the method further including deriving data objects from said document files or other data structures and applying said 3D effects rules to the data objects so derived.

43-78. (canceled)

79. A computer program product for implementing a method according to claim 39, the computer program product comprising one or more non-transitory computer-readable storage media having thereon computer-executable instructions that, when executed by one or more processors of a computing system, cause the computing system to perform the method.

80. A data processing system according to claim 1, wherein the 2D display items represent at least a portion of a page of a digital document received as input to the data processing system.

81. A data processing system according to claim 3, wherein the data objects are derived from source data which is inherently two-dimensional and intended for presentation on a 2D visual display by means of a 2D rendering system, and the rendering system is adapted to apply said 3D effects rules to data objects derived from said source data.
